(19) United States
(12) Patent Application Publication
(10) Pub. No.: US 2012/0156658 A1
(43) Pub. Date: Jun. 21, 2012

(54) METHODS FOR TEACHING AND/OR LEARNING CHINESE, AND RELATED SYSTEMS

(76) Inventor: Nicholas Fuzzell, Cottonwood, ID (US)

(21) Appl. No.: 12/969,943

(22) Filed: Dec. 16, 2010

(51) Int. Cl. G09B 19/06

(52) U.S. Cl. 434/157

(57) ABSTRACT

A method for teaching how to read and/or write Chinese, includes first, teaching each component in a group of components, and then, teaching how to combine one or more of the components in the group with one or more of the other components in the group to form a Chinese character. The group of components includes a component that is not identified as a Bùsh\check{o}u, and each component in the group is combinable with one or more other components in the group to form a Chinese character. By first teaching each component and its semantic meaning, a student can become knowledgeable and familiar with each component. The student can then use this depth of understanding to quickly and efficiently recognize and understand Chinese characters—including ones that he may not have previously memorized, or previously memorized and subsequently forgot. Thus, the components in the group of components become similar to the letters in an alphabet of a phonetic language.

### BACKGROUND

Learning to read and write Chinese is very difficult—much more difficult than learning English. A primary reason for this is that Chinese is not a phonetic language in which words are constructed by combining one or more letters from an alphabet of a small number of letters (26 letters for the English alphabet). Instead, Chinese is a graphical language in which words are expressed as characters. These characters are each either a pictograph (a graphical representation of a thing), an ideograph (a graphical representation of an abstract idea), or a combination of the two. Unlike phonetic languages in which the written word can be subdivided into the letters of the alphabet that together form the word, the written word in Chinese (the character) can not be easily subdivided. Because of this, there is no general rule or set of rules that one can learn to help oneself understand new characters. Although all Chinese characters include a radical portion (or Bùsh\check{o}u, which translated means “section header”), many of these radical portions were arbitrarily derived from the character's shape to facilitate indexing the characters in a Chinese dictionary. Thus, some of these derived radicals do not have a semantic meaning that contributes to the semantic meaning of the character that they are a part of.

Most students learning to read and write Chinese are typically taught a basic group of (3,000) characters that are most frequently used in everyday life. Typically, students are taught, and thus learn, these characters by first being taught the whole character; not subdivisions of the character. In a phonetic language, this would be analogous to learning words without learning the letters in the alphabet that make the words.

Because initially the task of learning 3,000+characters seems daunting, students are taught small groups of characters throughout elementary, middle, and high school. For example, a typical lesson involves a teacher introducing a new character followed by a student memorizing the character's meaning and form. The teacher then introduces, another character followed by the student memorizing this character's meaning and form. Because the radicals of the characters are usually, arbitrarily derived, and thus often have little bearing on the semantic meaning of the character, students are not taught radicals until much later in life, if at all.

Unfortunately, this method of simple, rote memorization of Chinese characters for learning how to read and write Chinese is tedious and not efficient. Characters previously learned are easily forgotten because the student is not taught a semantic context or a semantic association with the form of the character.

### SUMMARY

In an aspect of the invention, a method for teaching how to read and/or write Chinese, includes teaching each component in a group of components before teaching how to combine one or more of the components in the group with one or more of the other components in the group to form a Chinese character. The group of components includes a component that is not identified as a Bùsh\check{o}u, and each component in the group is combinable with one or more other components in the group to form a Chinese character. By teaching each component and its semantic meaning before a student learns how to combine two or more of the components, a student can become knowledgeable and familiar with each component. The student can then use this depth of understanding to quickly and efficiently recognize and understand Chinese characters—including ones that he may not have previously memorized, or previously memorized and subsequently forgot. Thus, the components in the group of components become similar to the letters in an alphabet of a phonetic language.

In another aspect of the invention, a method for teaching how to read and/or write Chinese includes teaching each component in a group of components that includes a Bùsh\check{o}u, before teaching how to combine one or more of the components in the group with one or more other components to form a Chinese character. Each component in the group is combinable with one or more other components in the group to form a Chinese character.

In yet another aspect of the invention, a method for learning how to read and/or write Chinese includes learning each component in a group of components before studying how to combine one or more of the components in the group with one or more of the other components in the group to form a Chinese character.

In some embodiments, the group of components includes the group of components identified in Table A. Table A includes four hundred twenty five (425) components of which eighty five (85) components are not conventional Bùsh\check{o}u. The eighty five components are not included in the five hundred forty (540) Bùsh\check{o}u used in the Shuowen Jiezi dictionary during the middles ages; and are not included in the two hundred fourteen (214) Bùsh\check{o}u used in the Kangxi Zidian dictionary, which is currently used. By learning each component in this group before learning how to combine them to form characters, one does not have to learn by rote memorization each of the three thousand plus (3,000+) Chinese characters, but rather, the smaller number of components (425) and then learn how to combine one or more of the components to form a character.

### BRIEF DESCRIPTION OF THE FIGURES

FIG. 1 is a flowchart of a method for teaching how to read and/or write Chinese, according to an embodiment of the invention.

FIG. 2 shows Table A which includes a list of components identified in the group of components mentioned in FIG. 1, according to an embodiment of the invention. Please note that FIG. 2 spans forty three (43) sheets or pages.

FIG. 3 shows Table B which includes a subset of components that are each included in Table A shown in FIG. 2, according to an embodiment of the invention. Please note that FIG. 3 spans nine (9) sheets or pages.

FIG. 4A is a chart showing zones in which components can be disposed relative to other components to form a Chinese character within a region.

FIG. 4B shows examples of components disposed in the zones shown in FIG. 4A to form a character within a region.

FIG. 5 is a table of five (5) Chinese characters each representing a noun and each including a component from the group of components shown in FIG. 2.

FIG. 6 is a table of five (5) Chinese characters each representing a verb and each including a component from the group of components shown in FIG. 2.

FIG. 7 is a table of five (5) Chinese characters each representing an adjective and each including a component from the group of components shown in FIG. 2.

FIG. 8 is a table of five (5) Chinese characters each representing an adverb and each including a component from the group of components shown in FIG. 2.

FIG. 9 is a table of five (5) Chinese characters each representing a preposition and each including a component from the group of components shown in FIG. 2.

FIG. 10 is a table of five (5) Chinese characters each representing a conjunction and each including a component from the group of components shown in FIG. 2.

FIG. 11 is a schematic block diagram of a system for teaching how to read and/or write Chinese, according to an embodiment of the invention.

### DETAILED DESCRIPTION

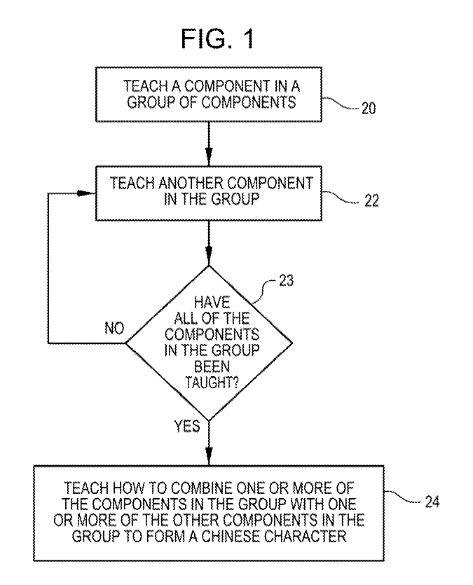

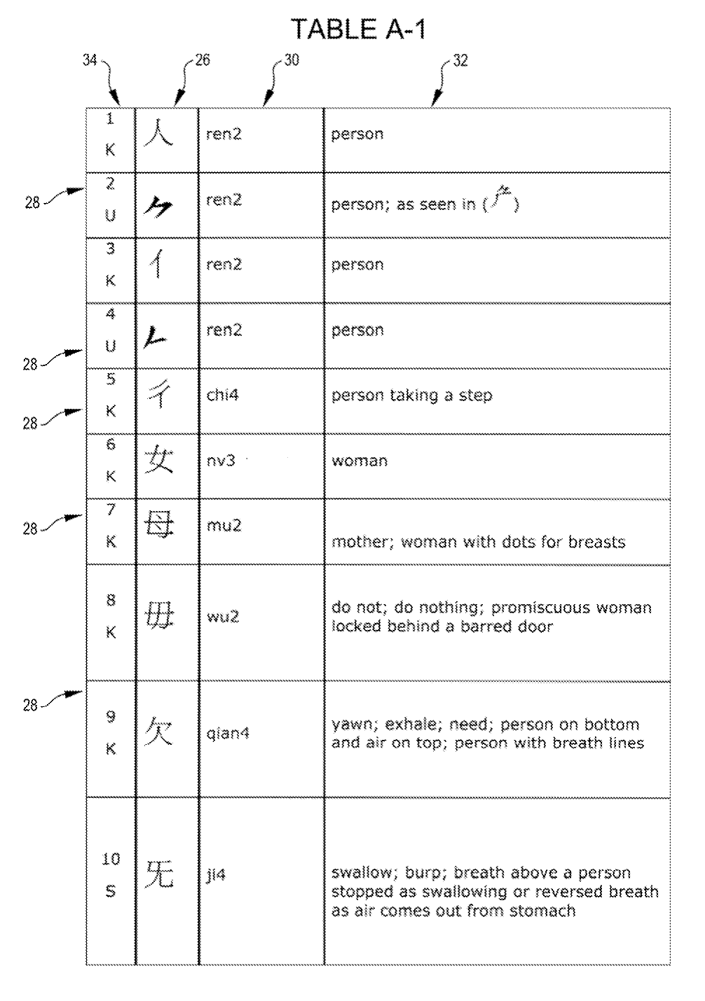

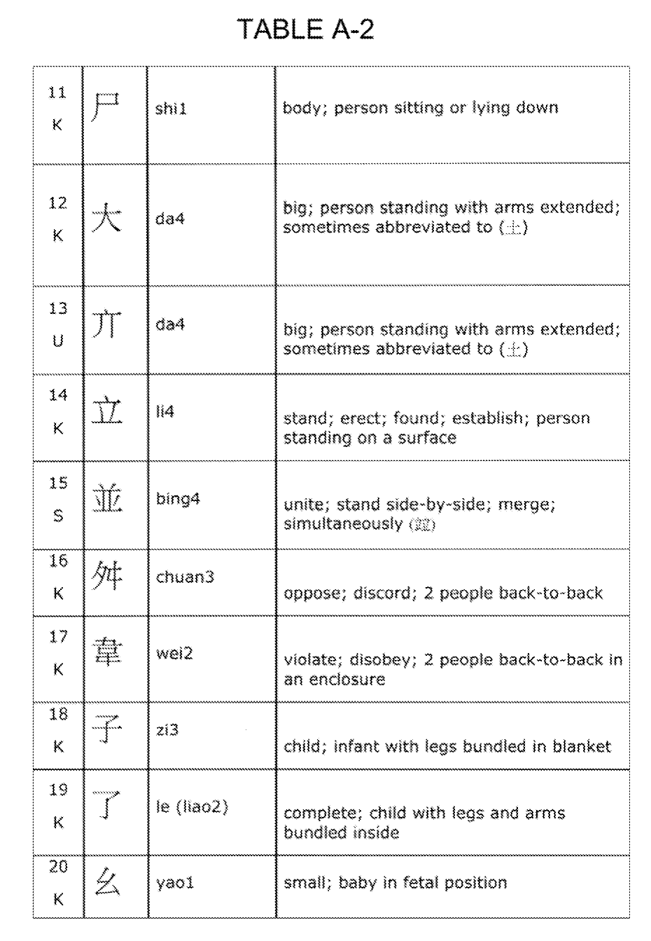

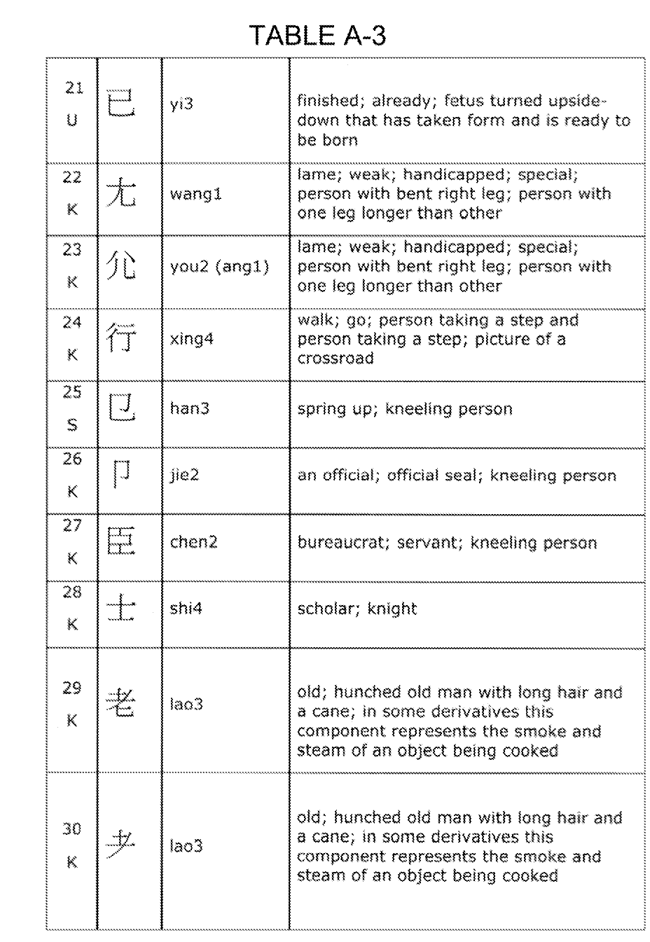

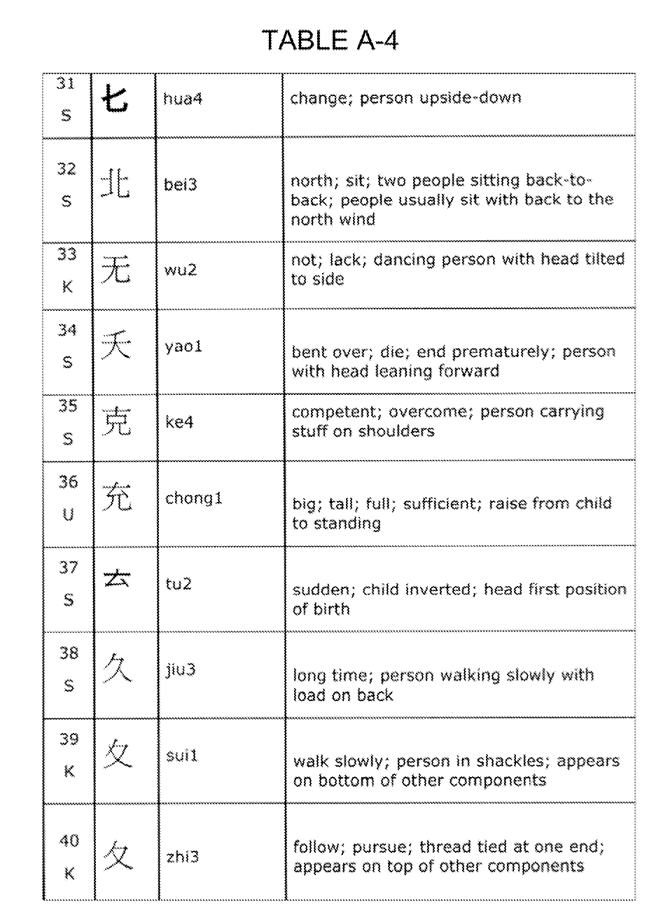

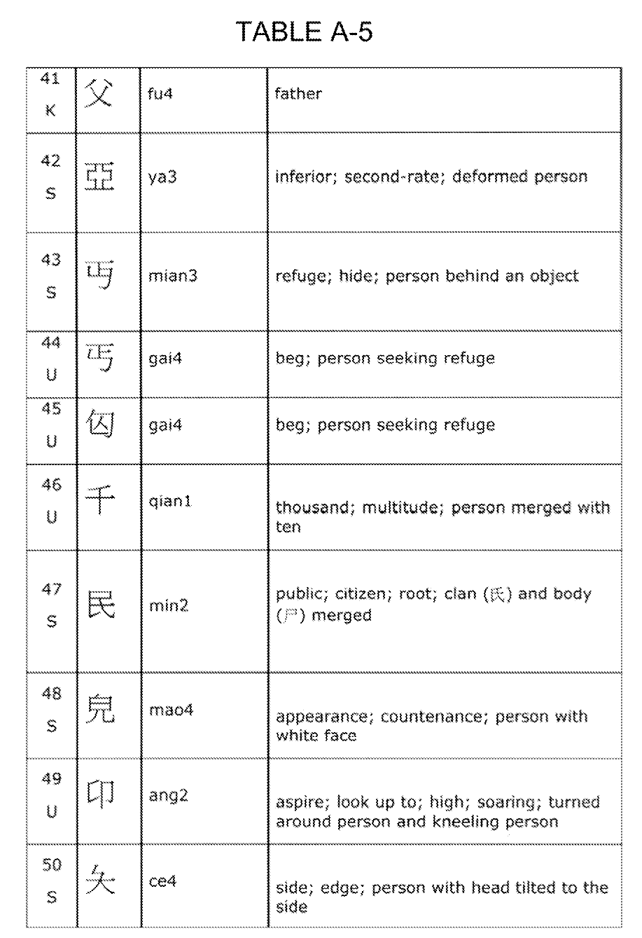

FIG. 1 is a flowchart of a method for teaching how to read and/or write Chinese, according to an embodiment of the invention. The method includes teaching each component in a group of components before teaching how to combine one or more of the components in the group with one or more of the other components in the group to form a Chinese character. Although a method for teaching how to read and/or write Chinese is discussed, the method is also applicable to learning how to read and/or write Chinese. The difference being the person or entity that performs the acts included in the method—a teacher teaches, and a student learns and/or studies. In addition, although the embodiment of the method shown in FIG. 1 includes teaching how to combine one or more of the components in the group with one or more of the other components in the group to form a Chinese character, other embodiments of the method may not include subsequently teaching how to combine two or more components to form a character.

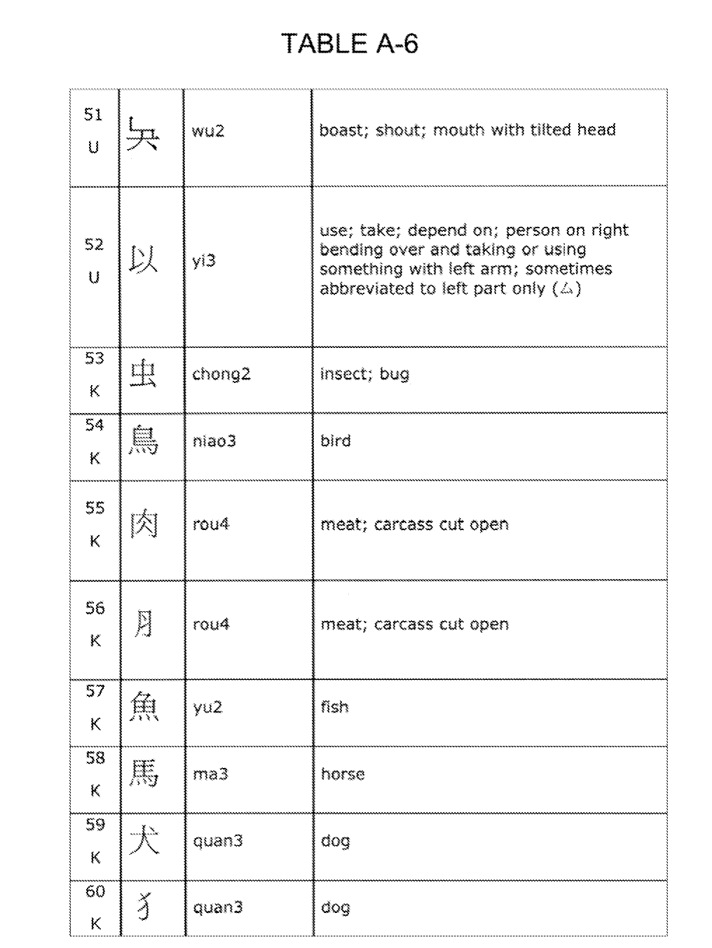

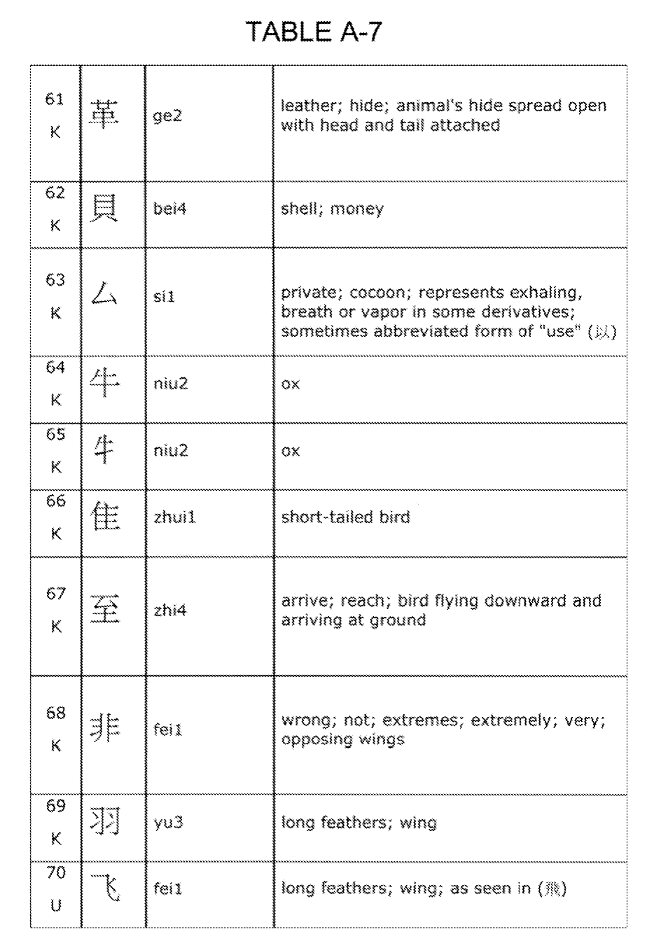

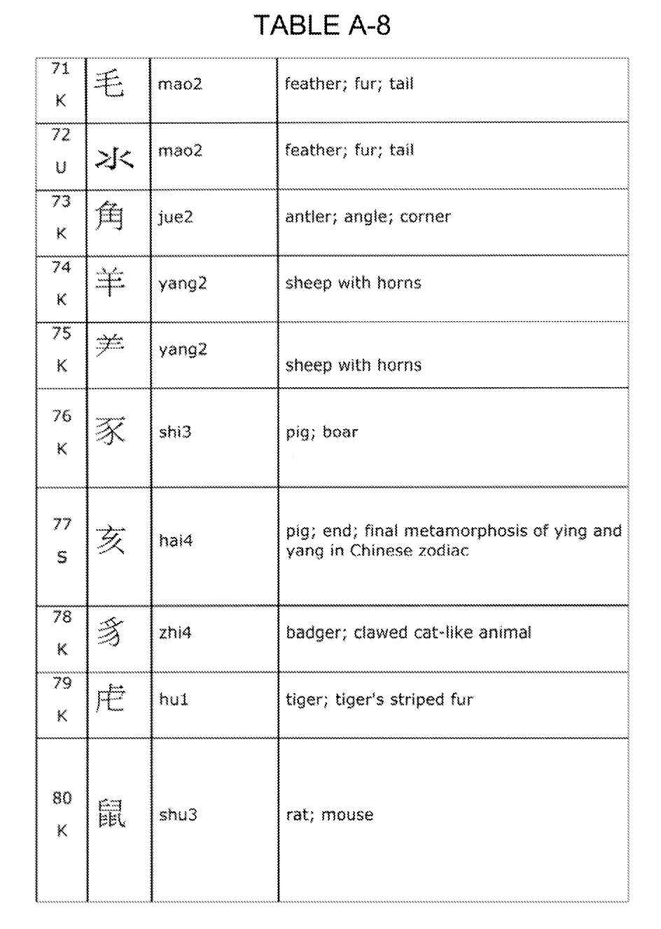

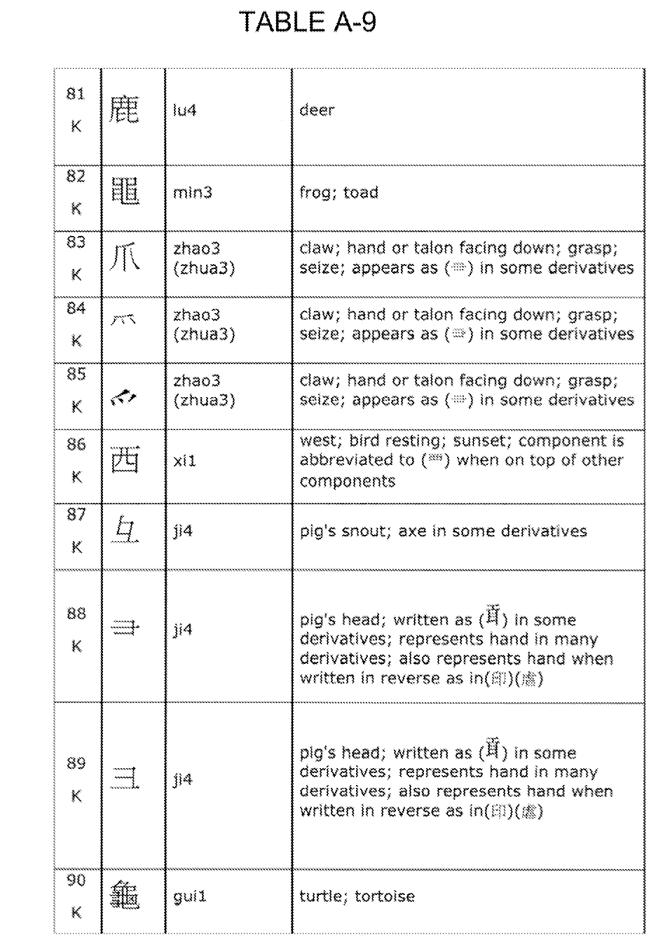

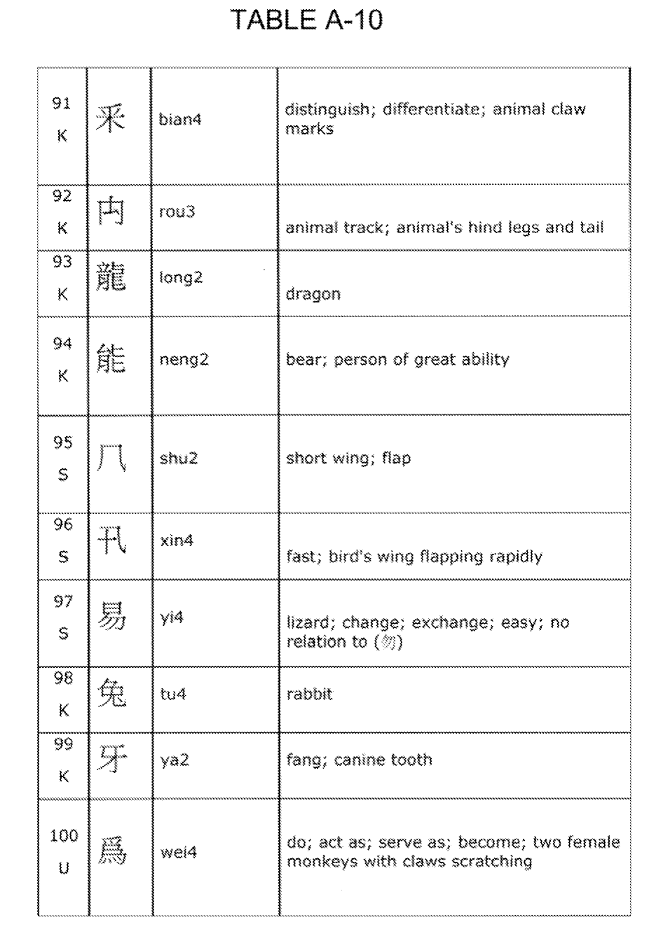

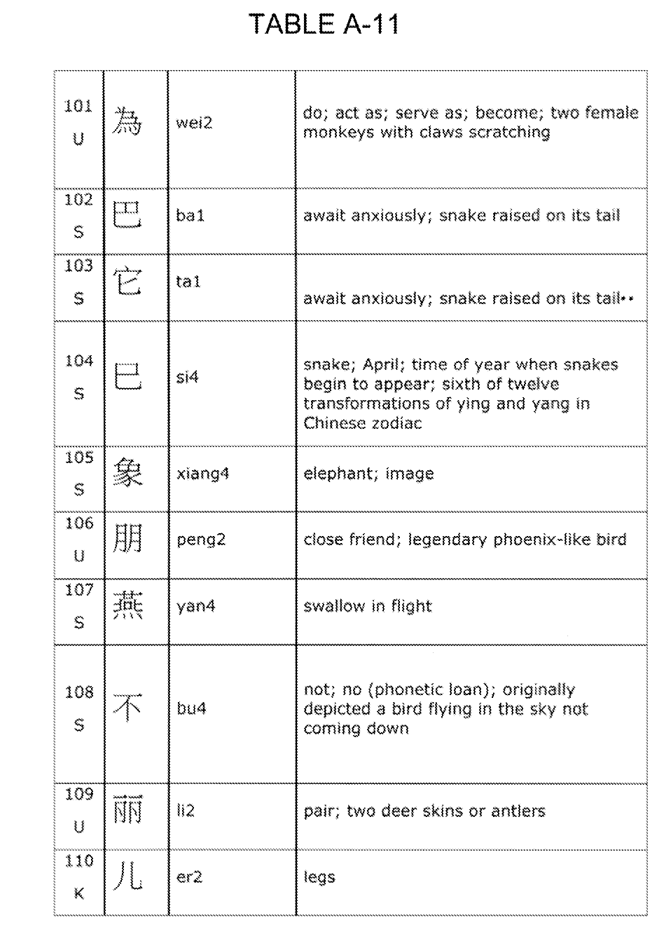

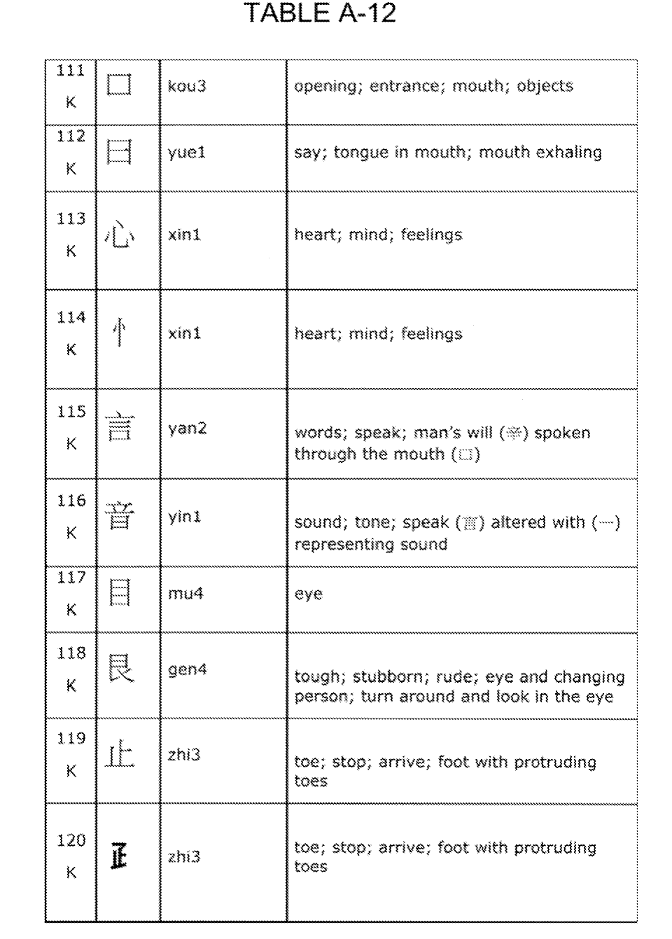

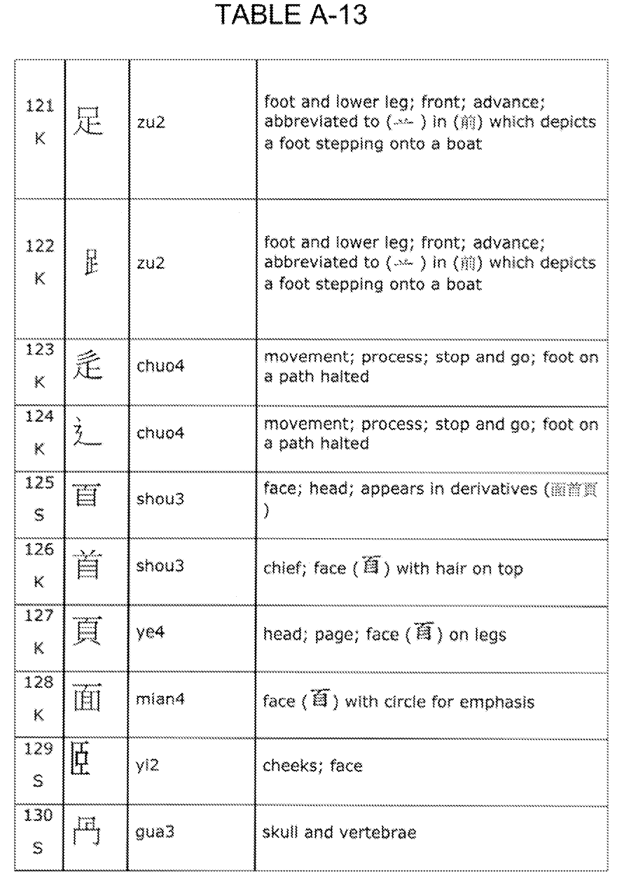

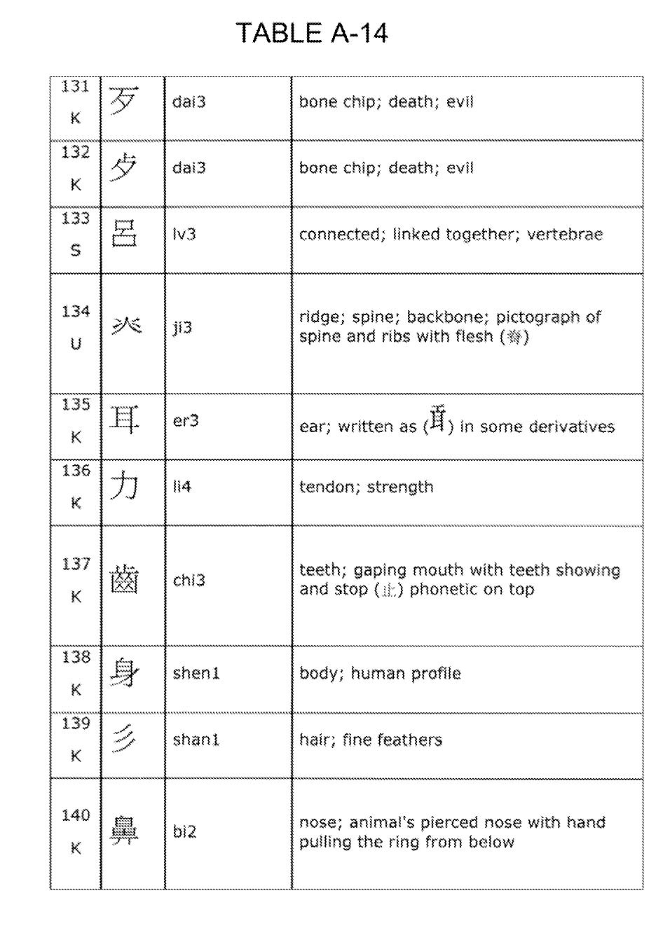

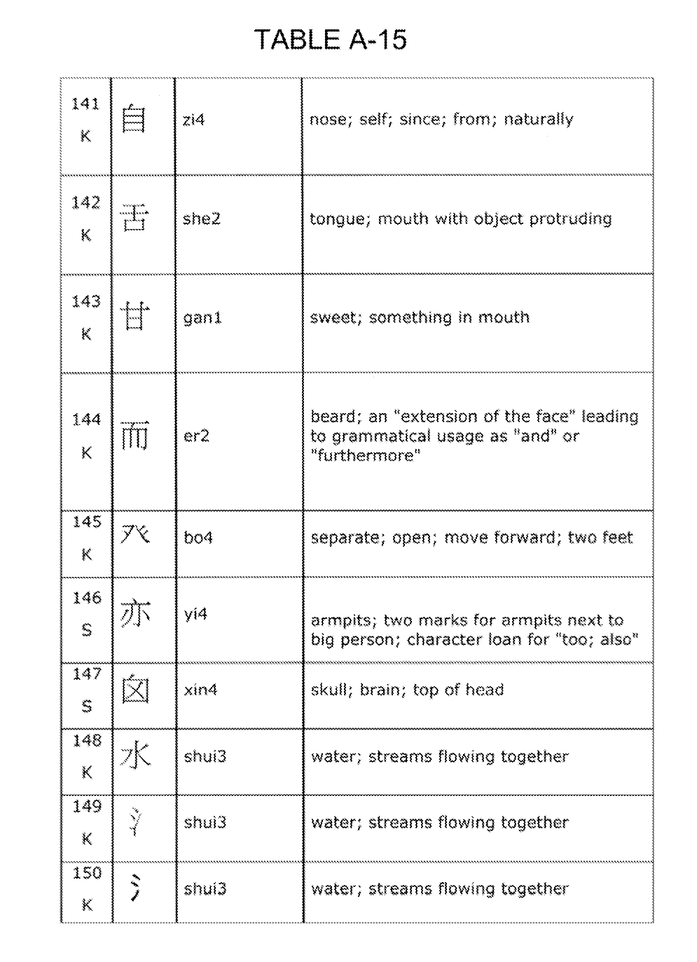

The group of components can include any desired component that is combinable with other components in the group to form a Chinese character, and that has a semantic meaning. Thus, a Bùsh\check{o}u that does not have a semantic meaning would not be a component included in the group. For example, the Kangxi Bùsh\check{o}u [symbol] has no semantic meaning by itself, and thus would not be included in the group. In some embodiments of the method, the group of components can include four hundred twenty five (425) components (shown in Table A and discussed in greater detail in conjunction with FIG. 2), of which eighty five (85) components (shown in Table B and discussed in greater detail in conjunction with FIG. 3) are not conventional Bùsh\check{o}u. Bùsh\check{o}u are graphic portions of Chinese characters which are used for organizing entries in Chinese dictionaries in sections which all share the same Bùsh\check{o}u or graphic portion. Some Bùsh\check{o}u include a semantic characteristic that adds to the semantic meaning of the character that it forms a part of. But, some Bùsh\check{o}u are simply a graphic element, such as a horizontal stroke, of a character. In other embodiments of the method, the group of components can include one or more of the eighty five (85) components shown in Table B that are not conventional Bùsh\check{o}u. In yet other embodiments of the method, the group of components can include one or more Bùsh\check{o}u that has a semantic meaning.

Teaching each component includes teaching the visual form and a semantic meaning of the component. Some components have more than one semantic meaning while others have one. Teaching each component may furthermore include showing a character as an example of how a component is visually a portion of the character. Such a showing would be used to provide a student a foreshadowing of the purpose for teaching each component, not to teach how to form a character by combining components visually and semantically.

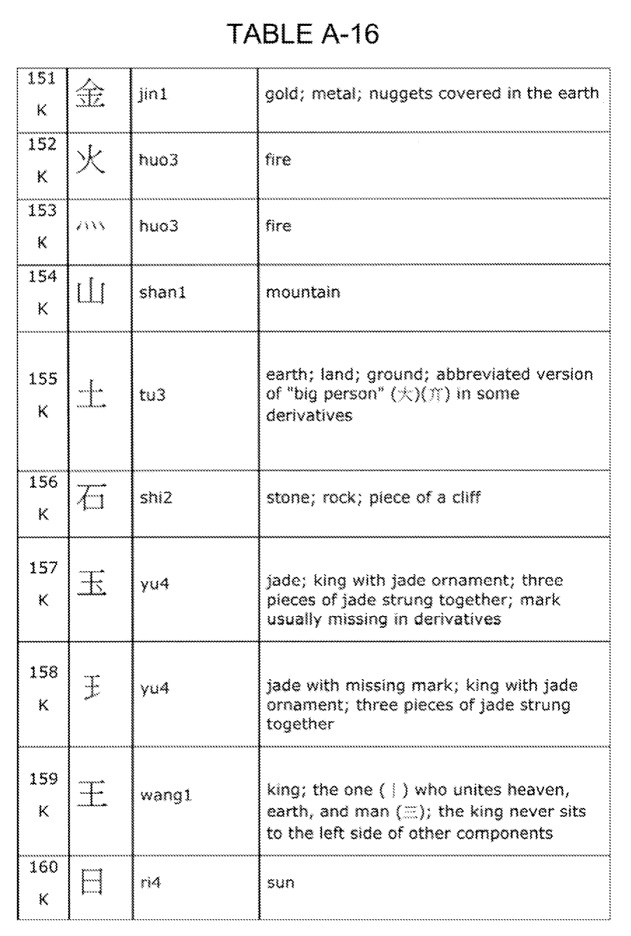

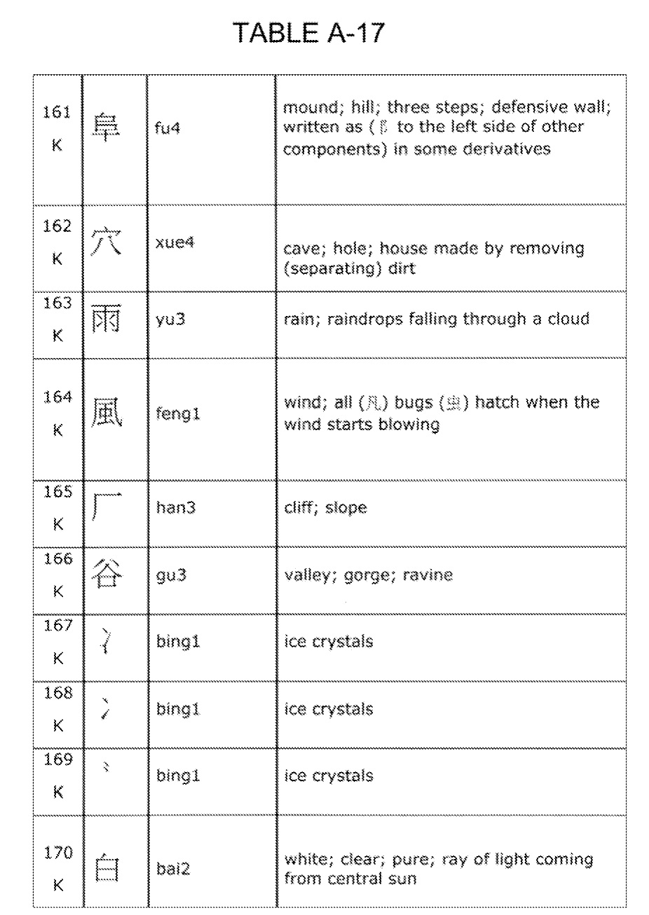

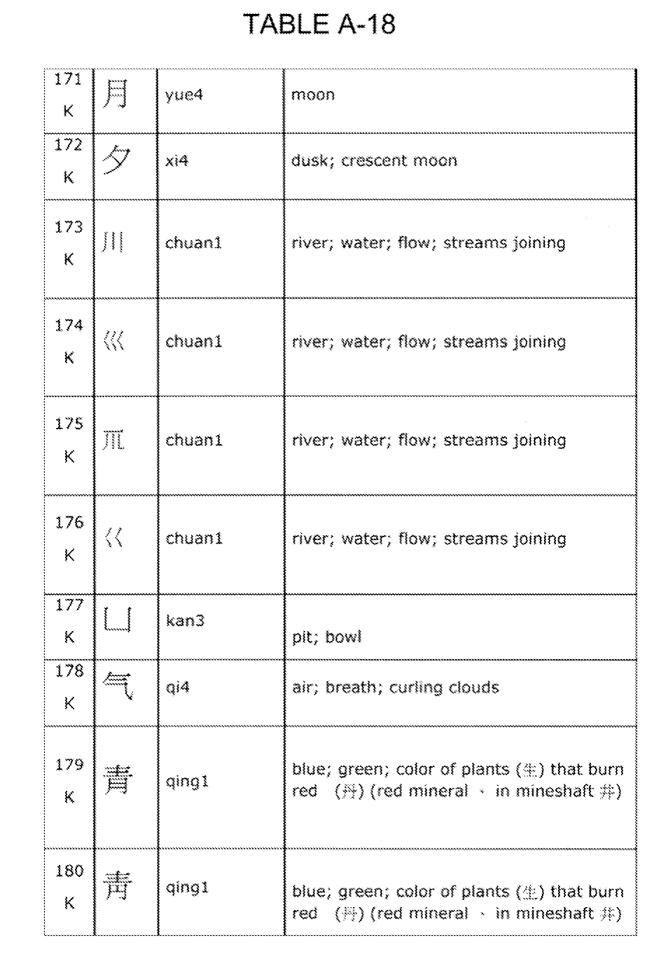

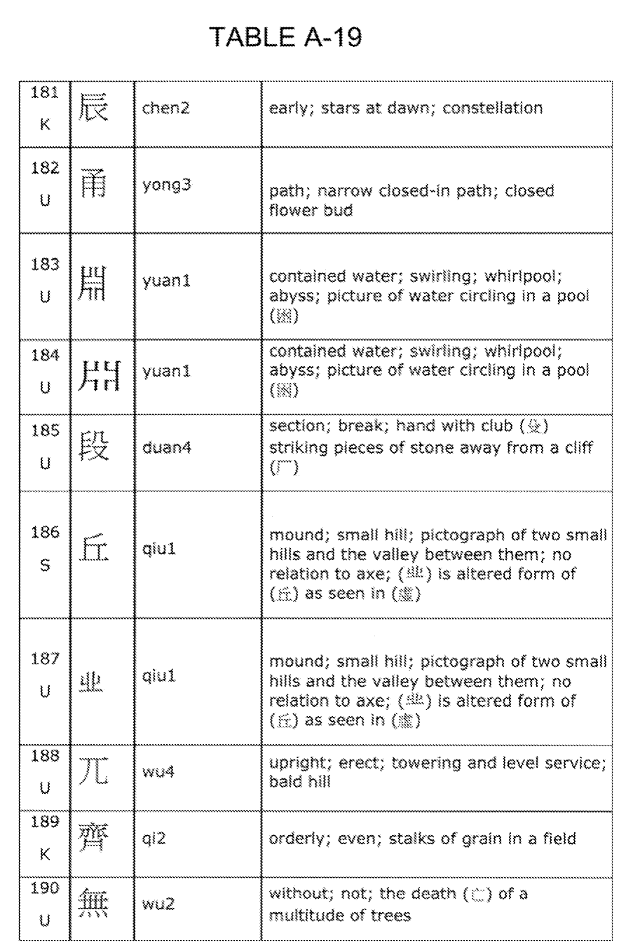

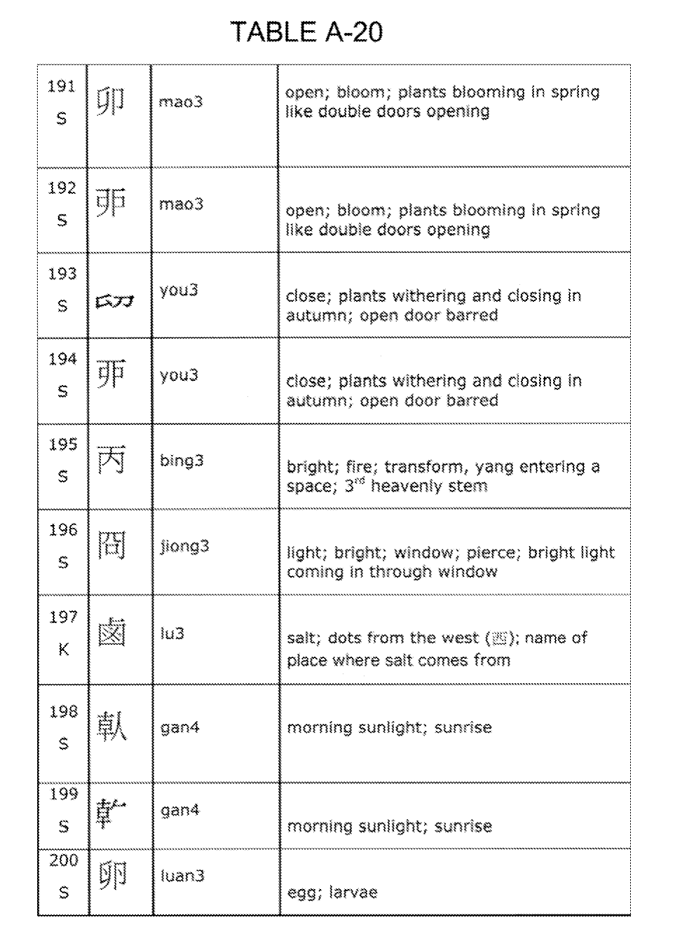

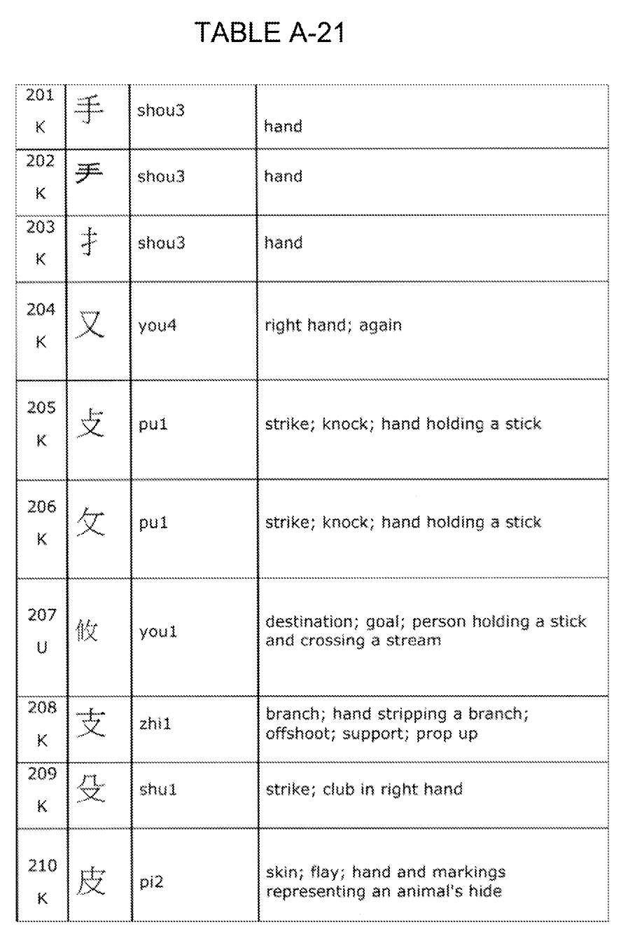

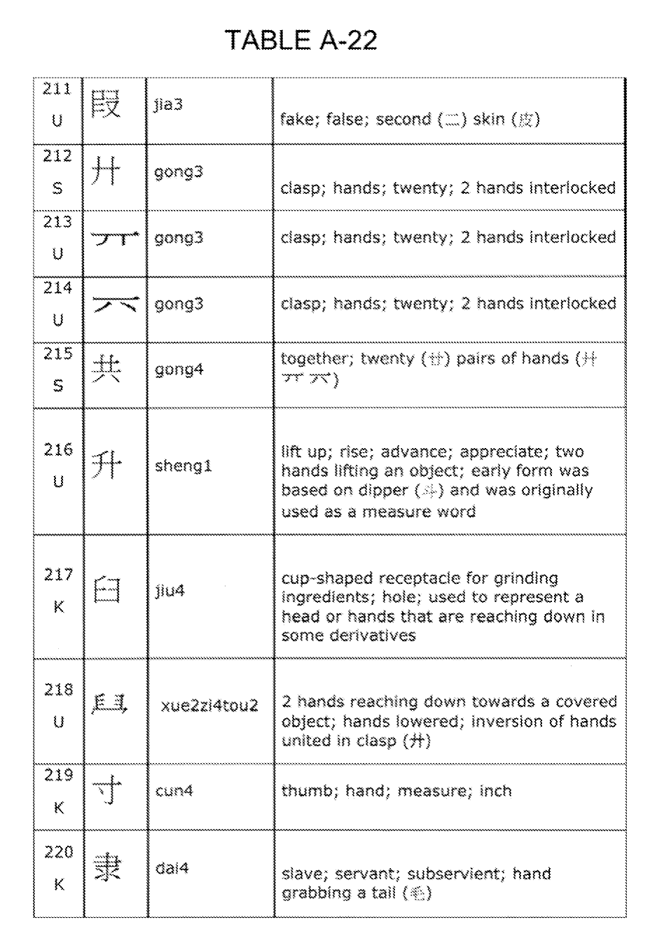

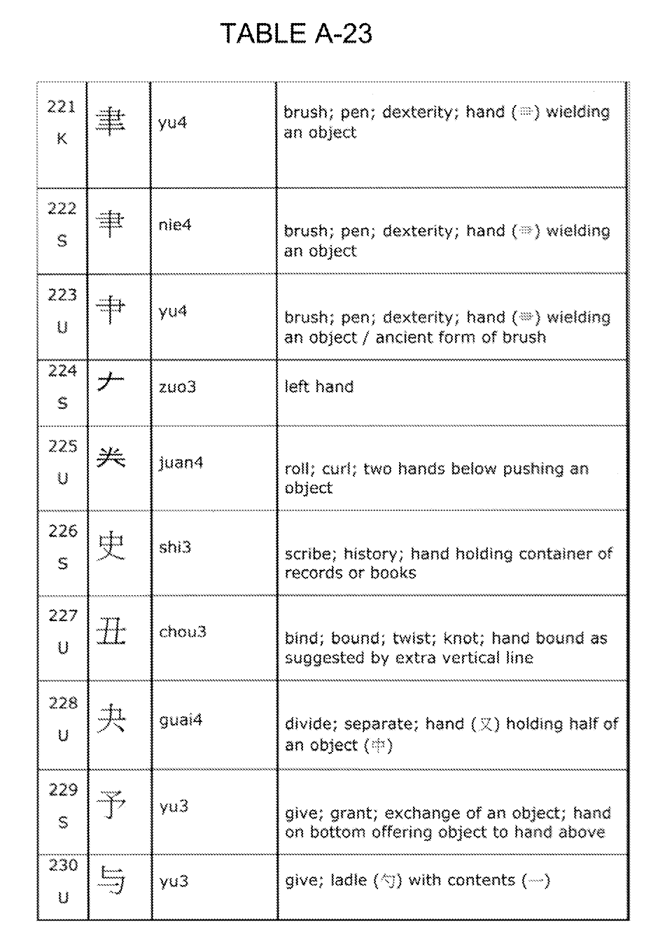

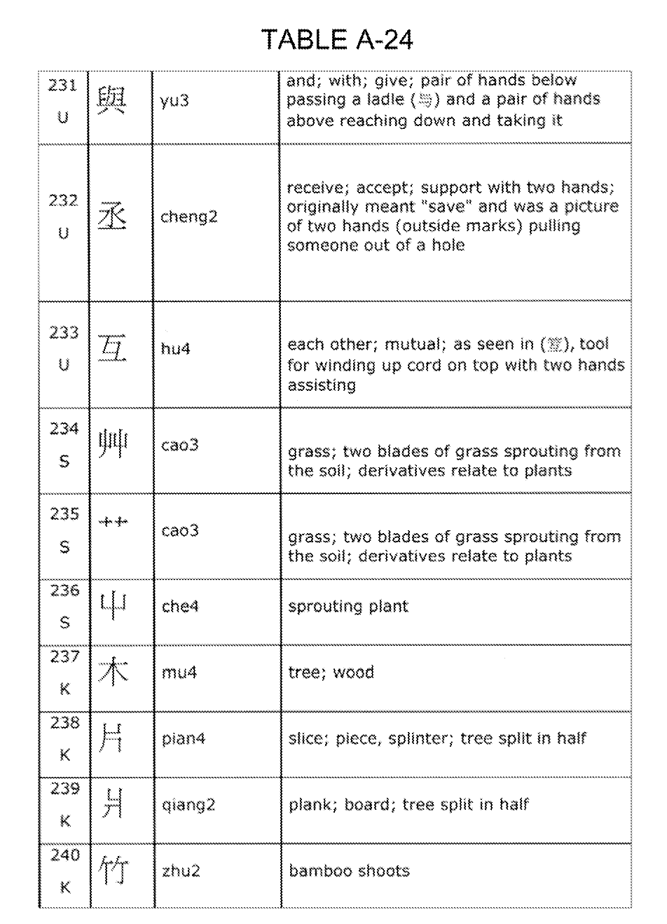

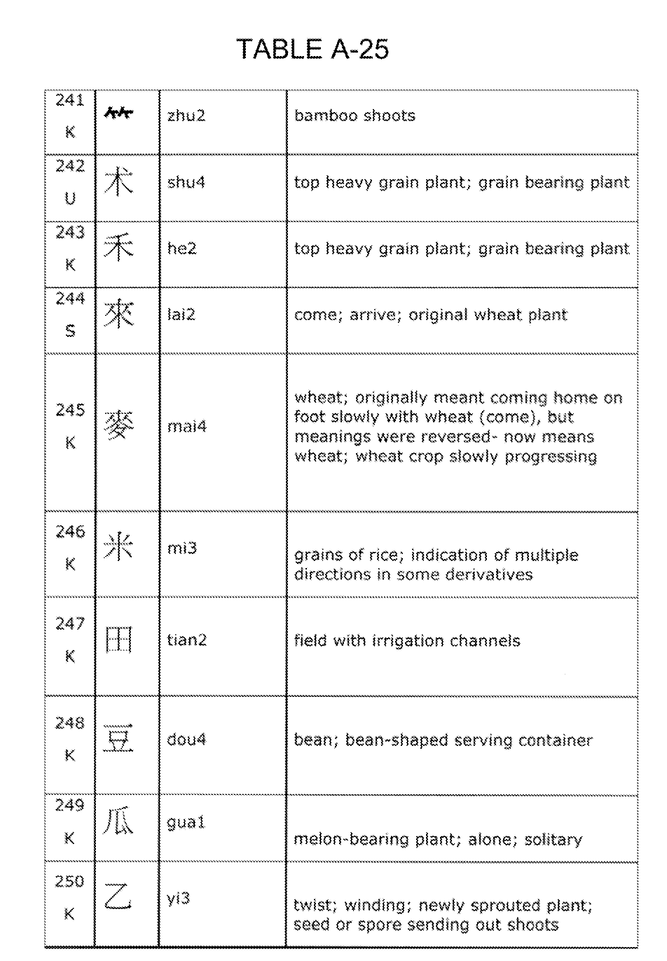

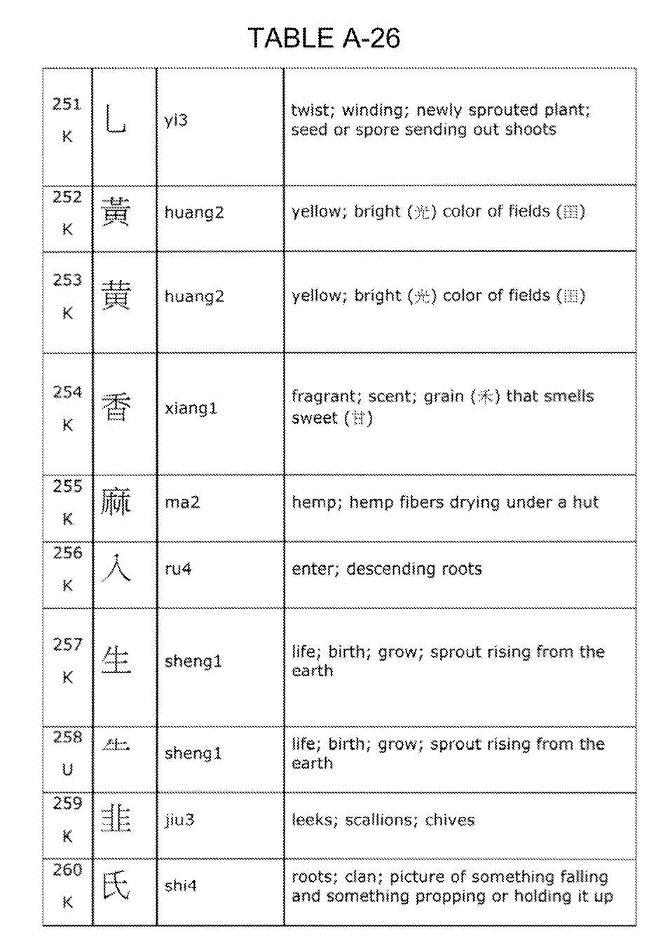

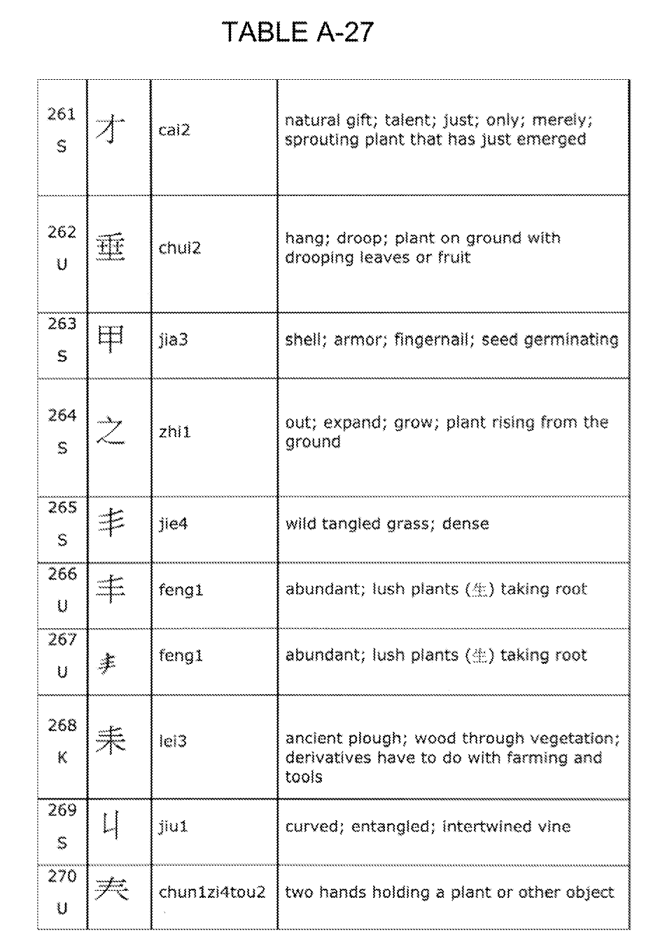

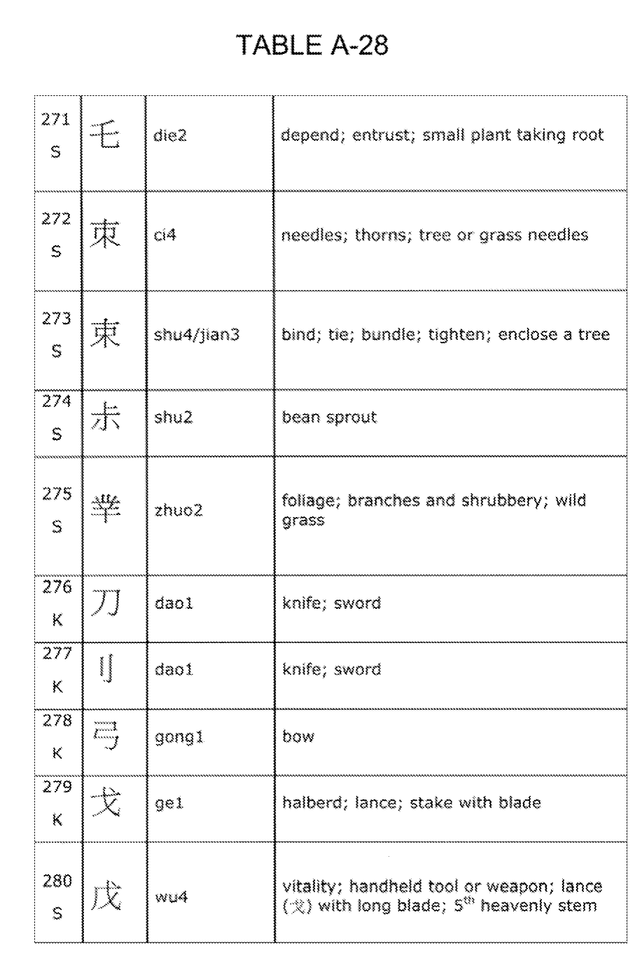

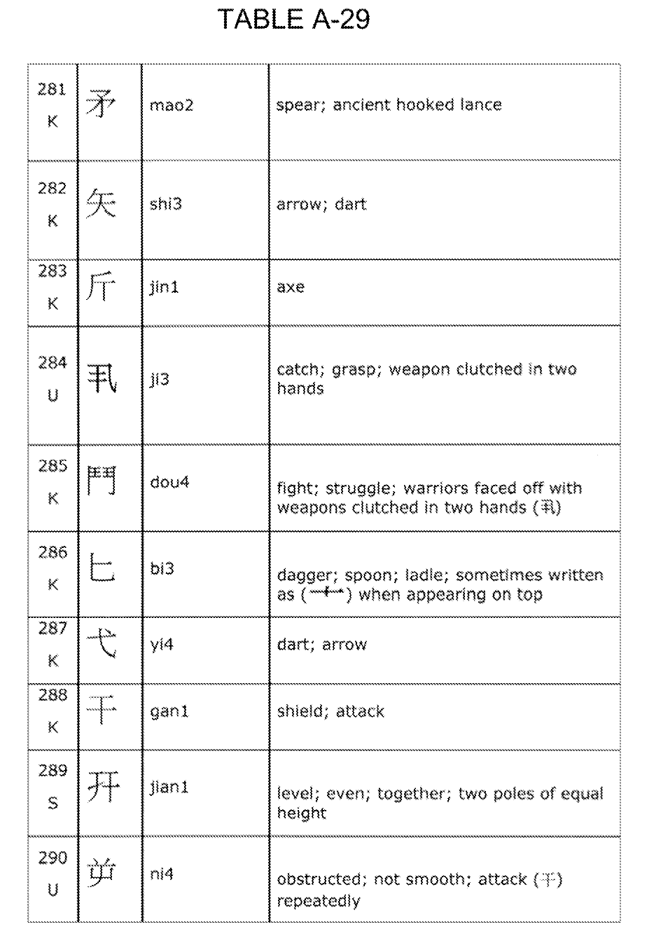

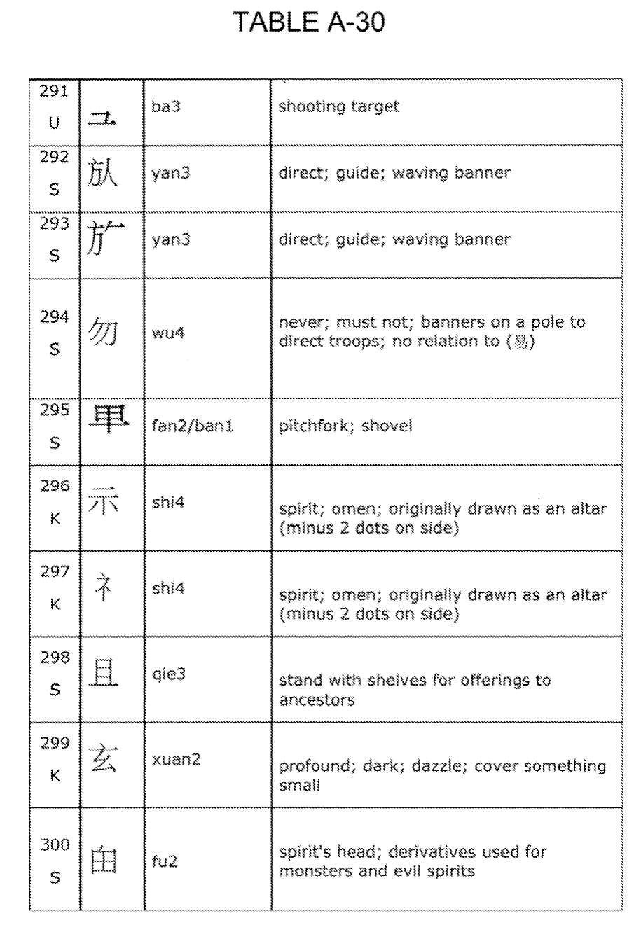

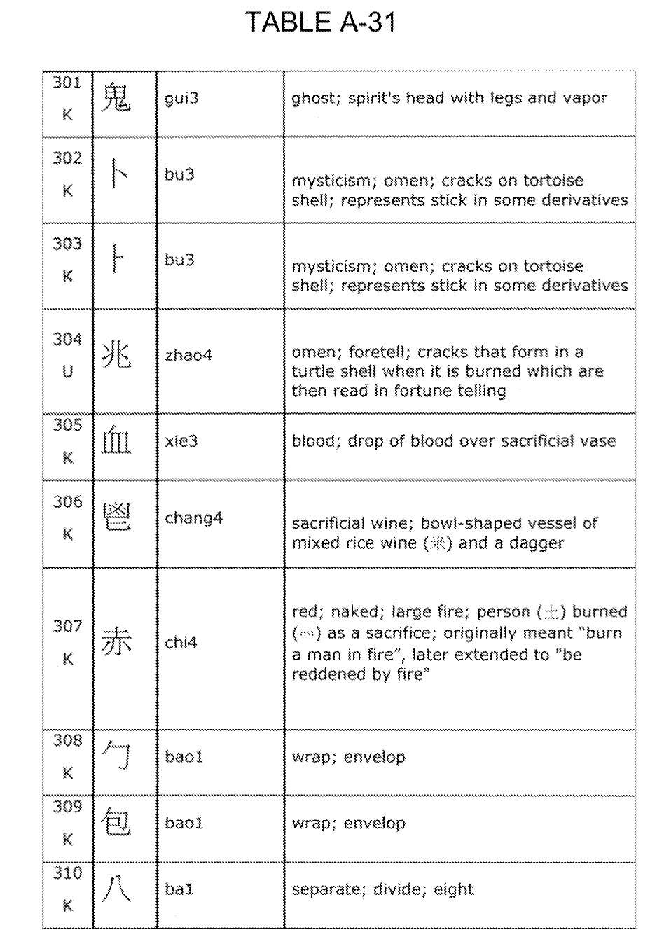

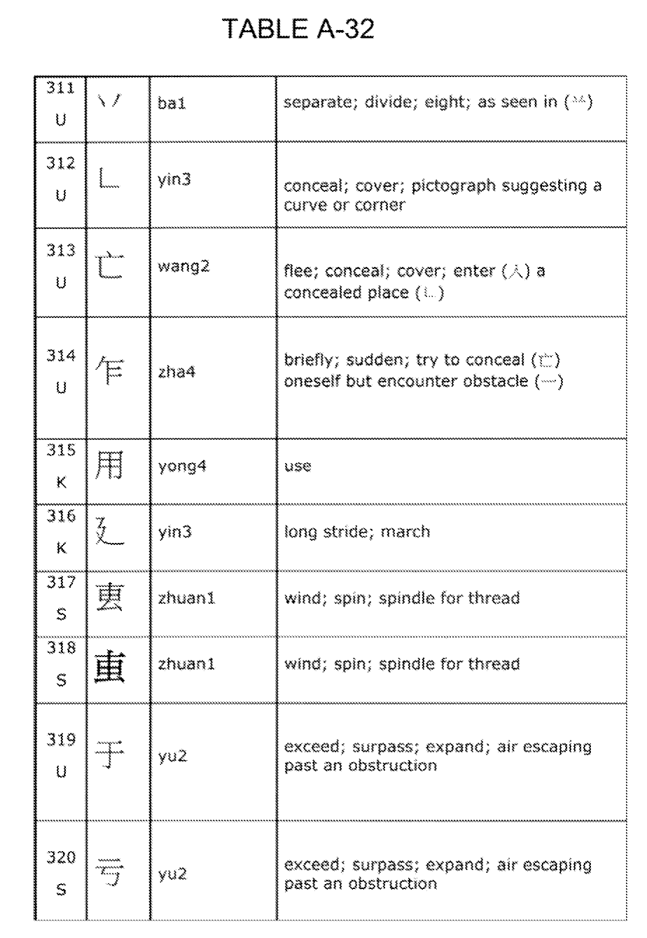

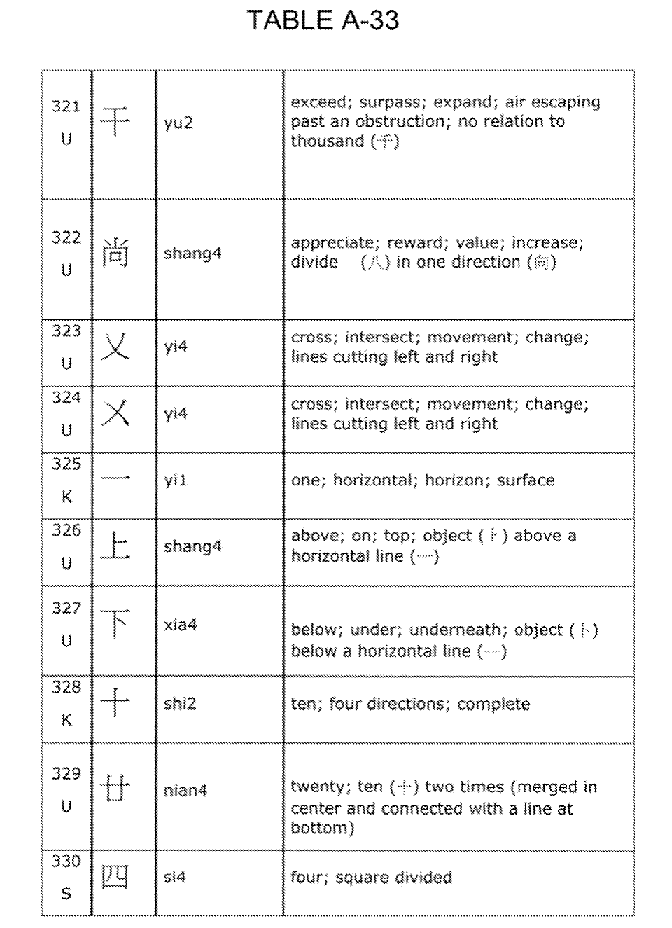

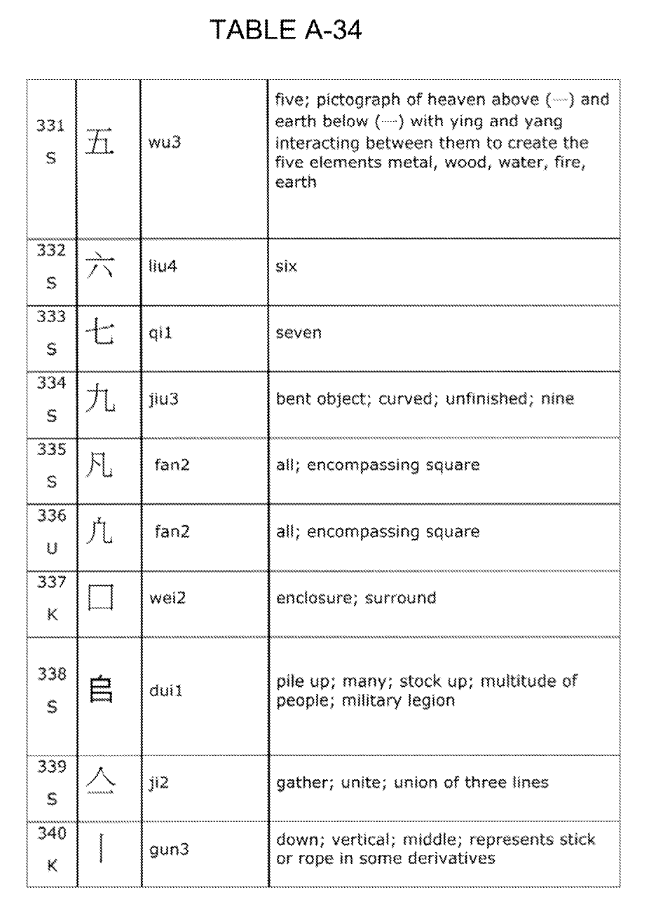

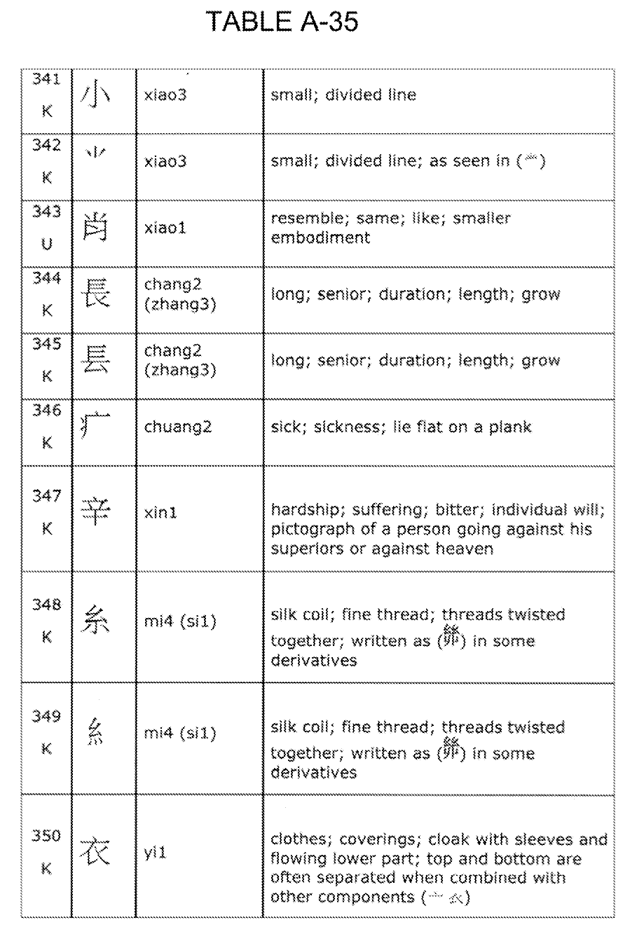

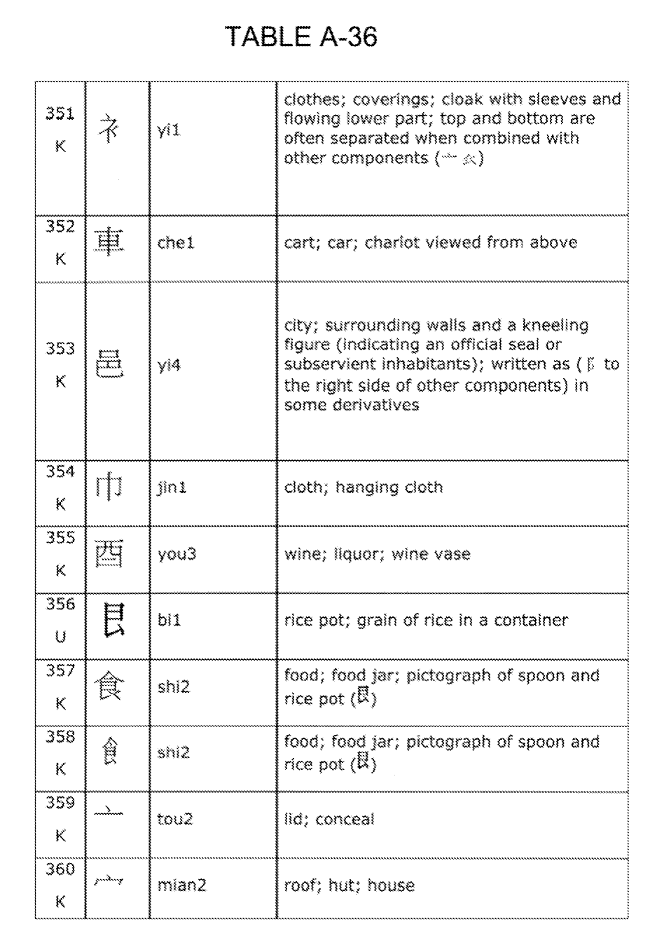

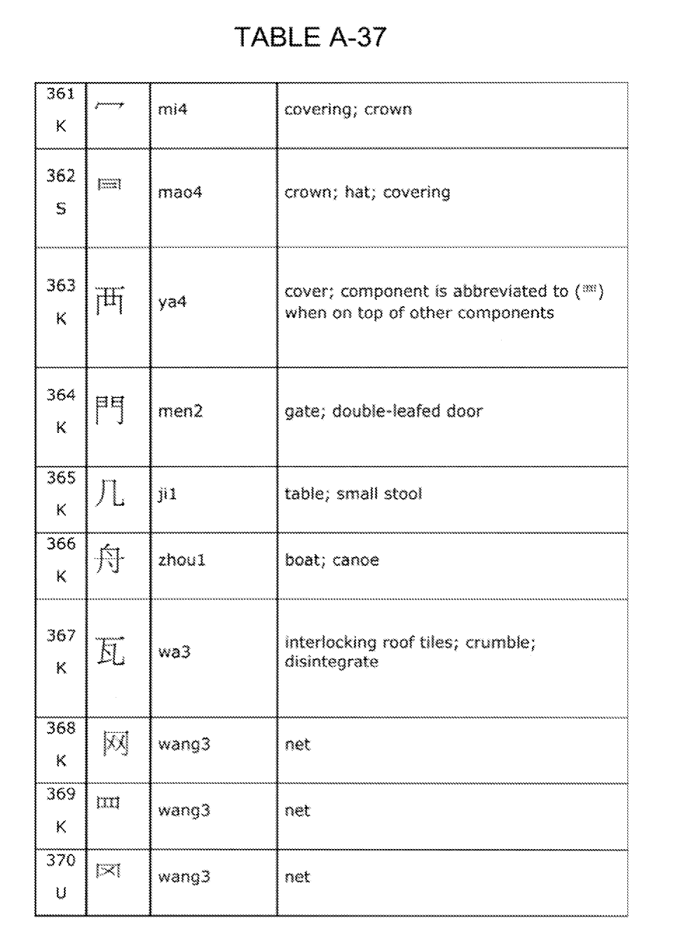

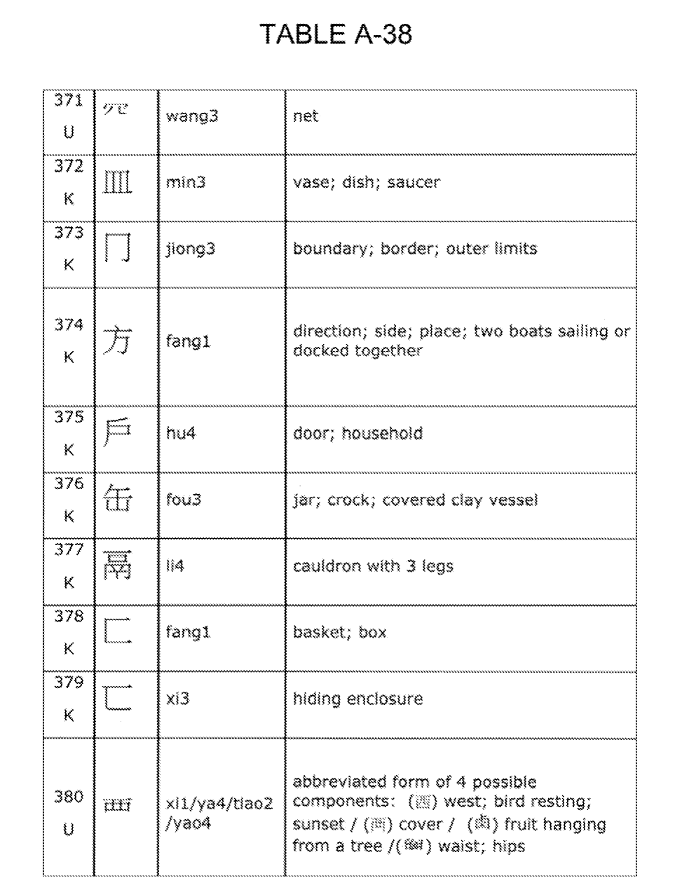

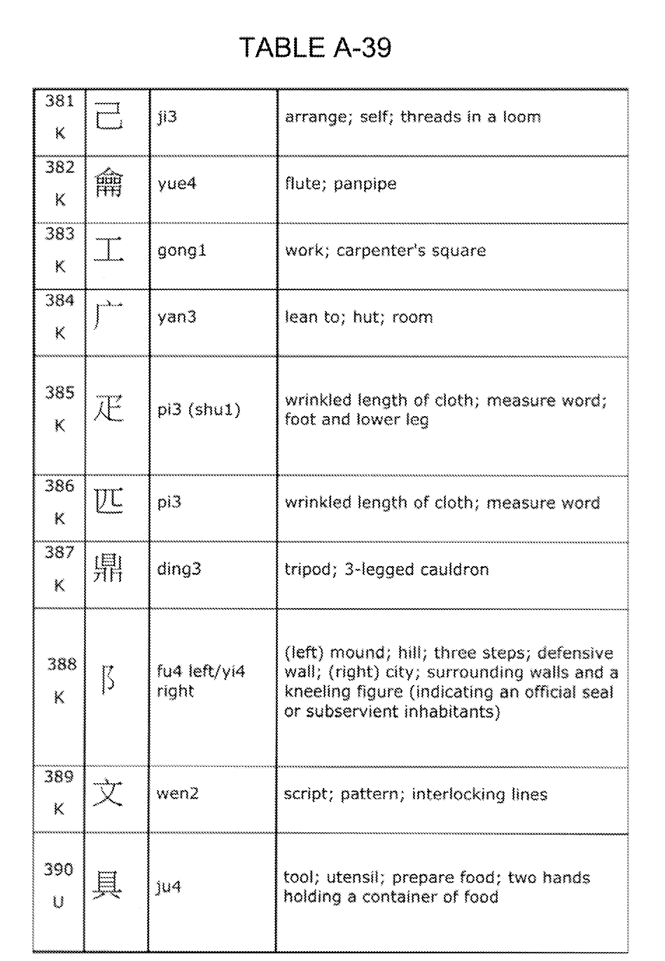

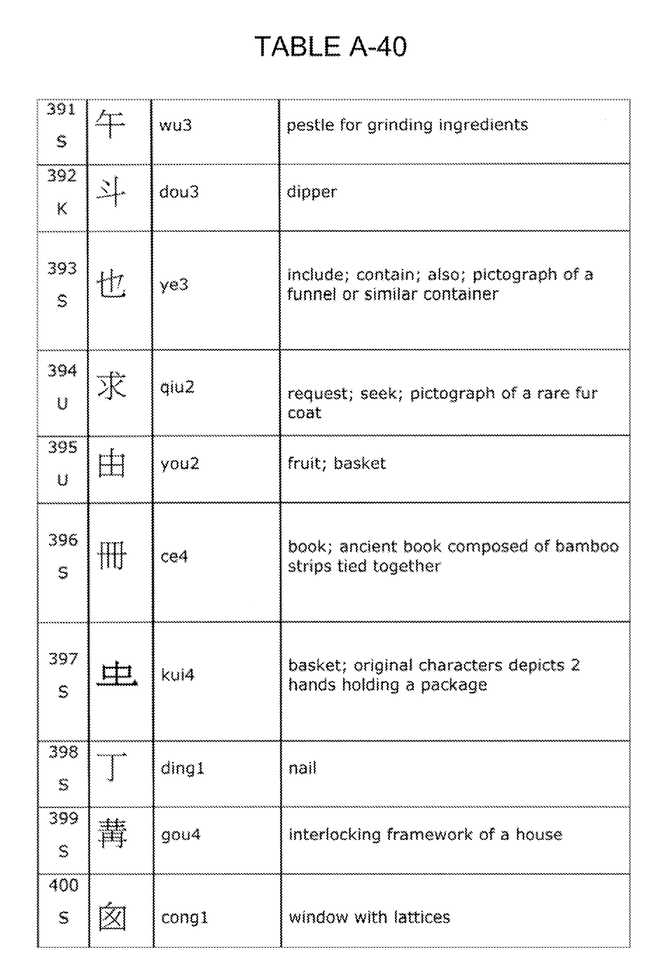

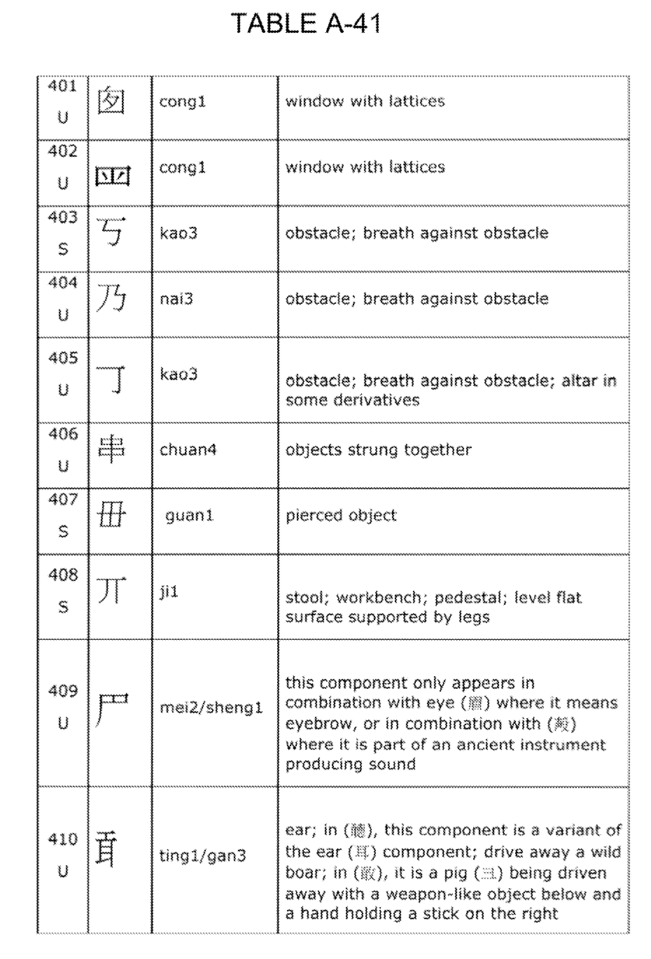

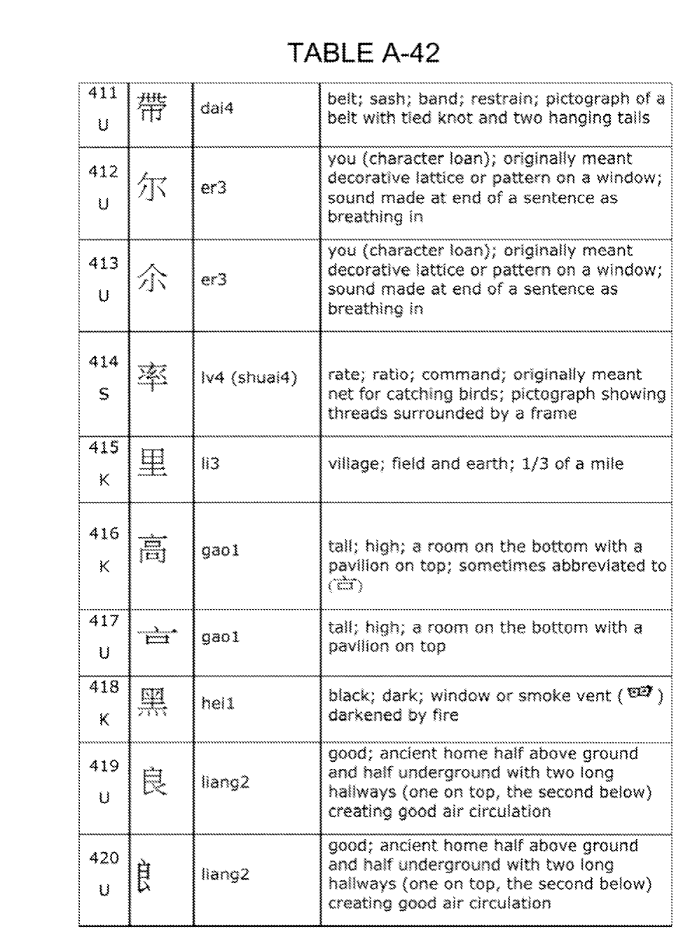

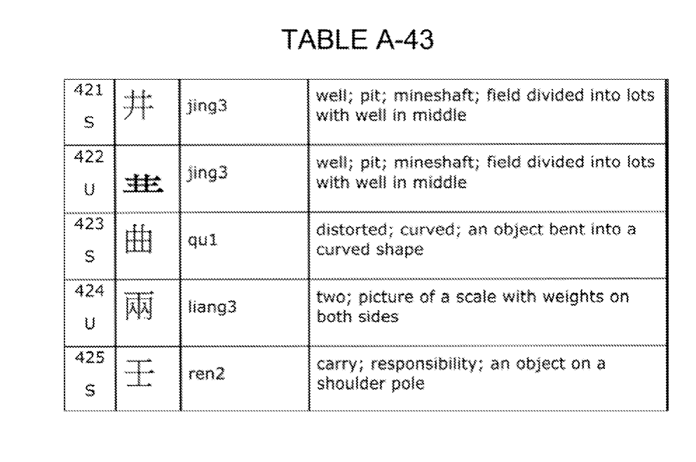

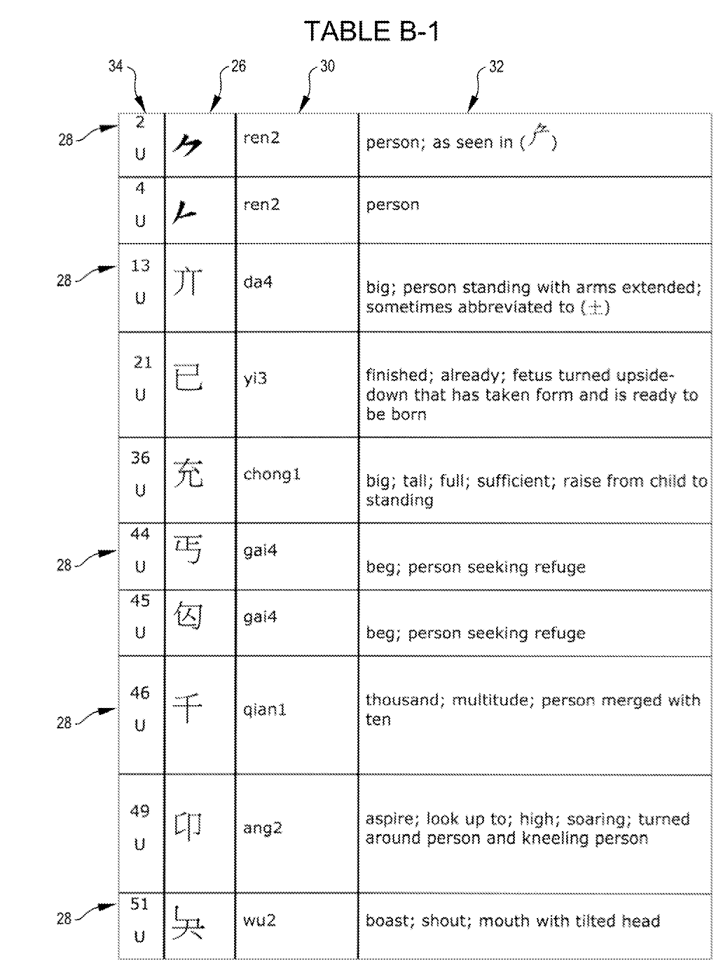

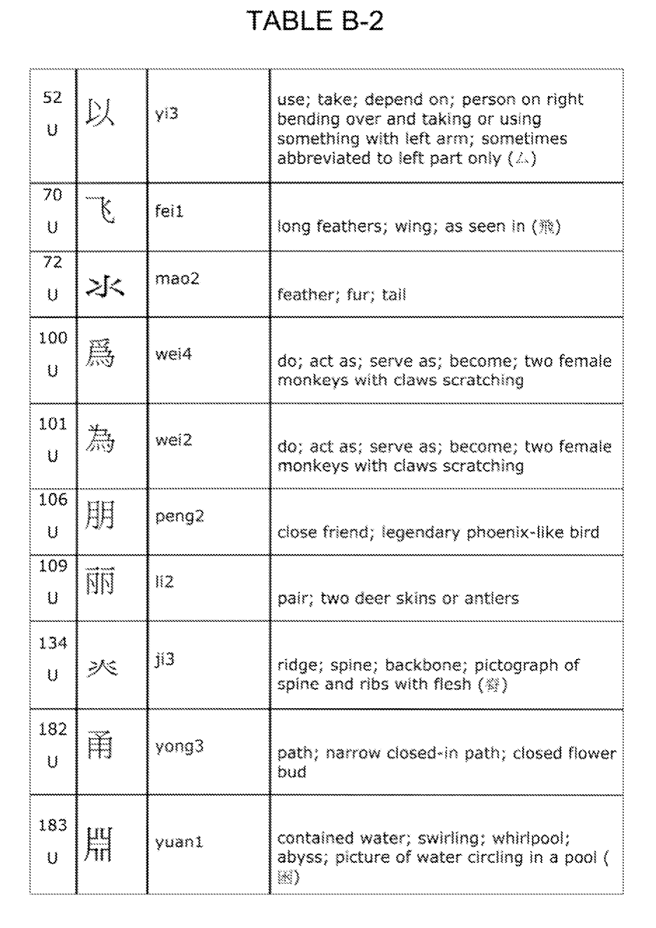

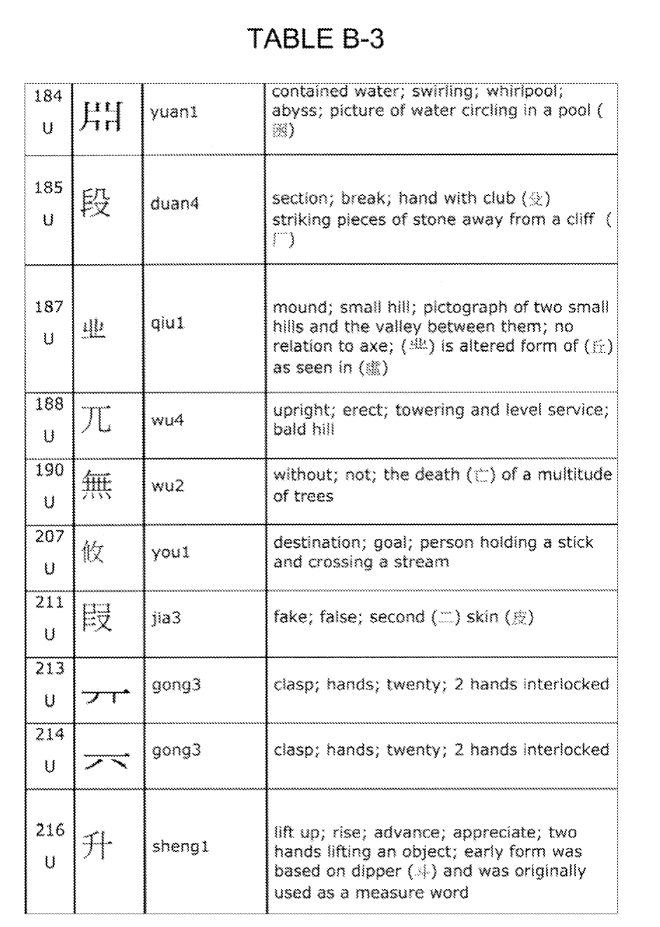

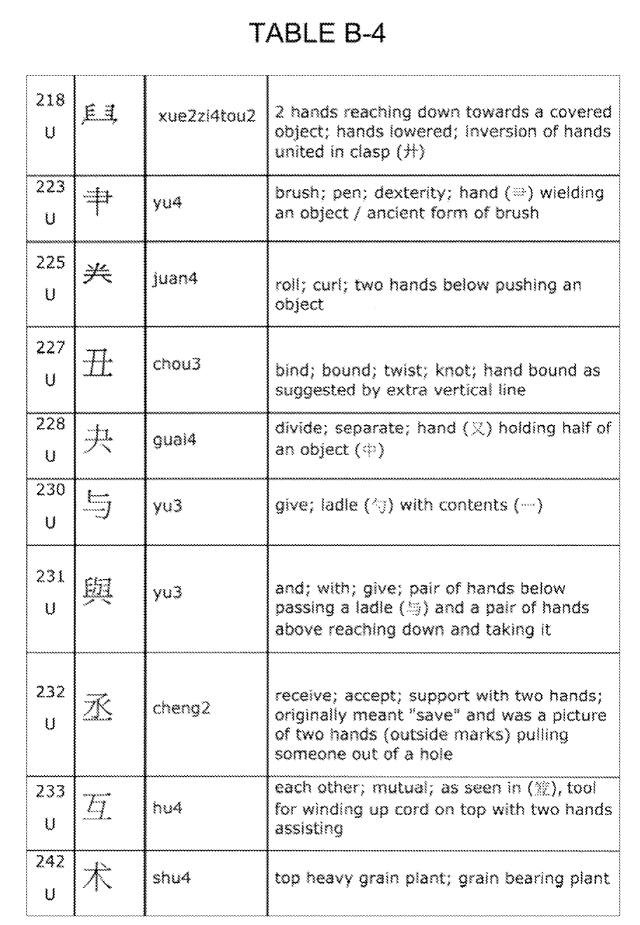

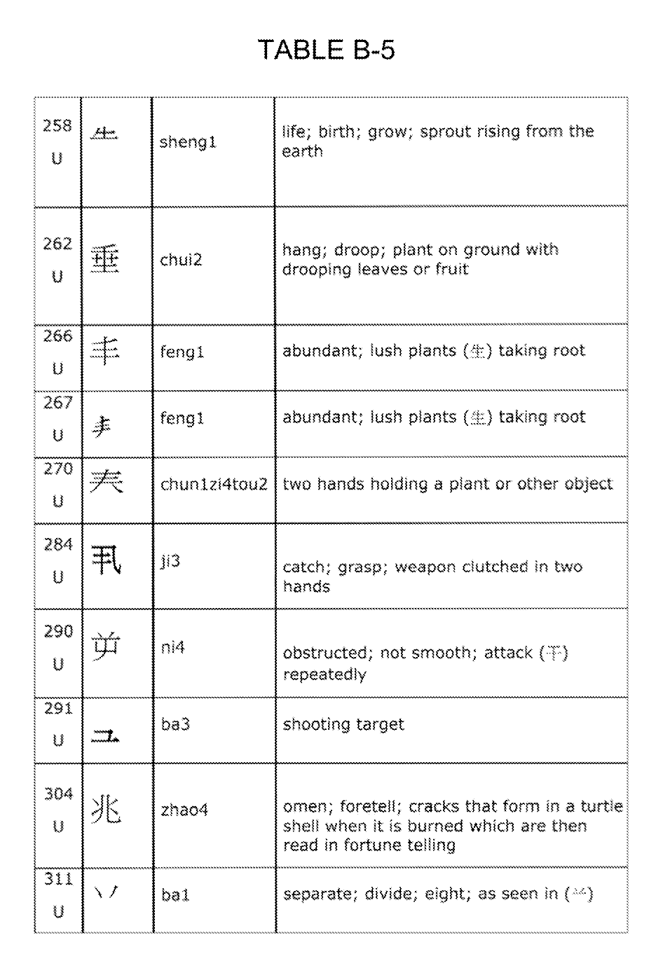

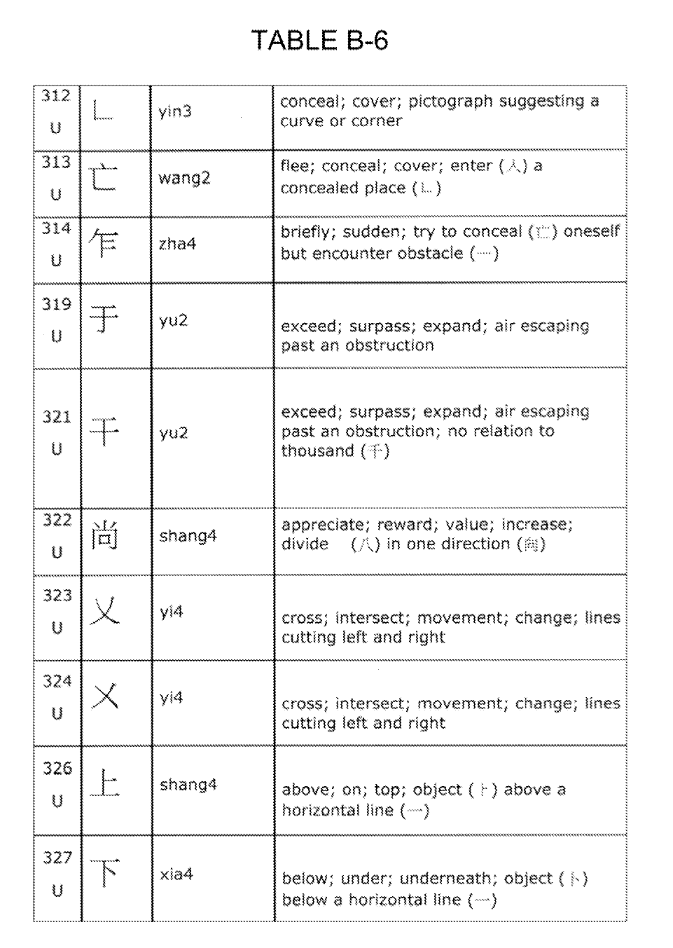

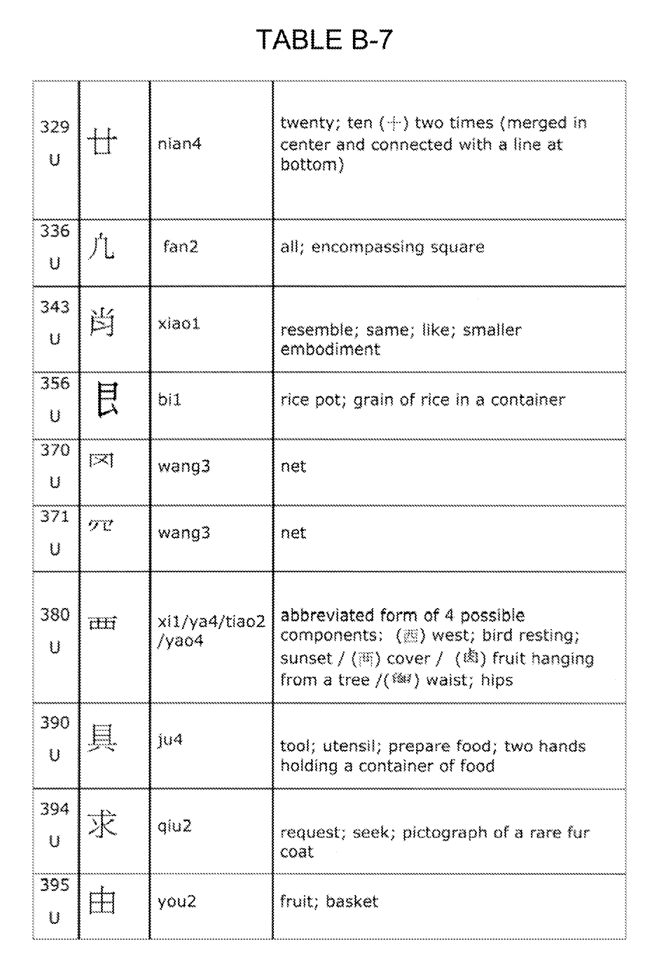

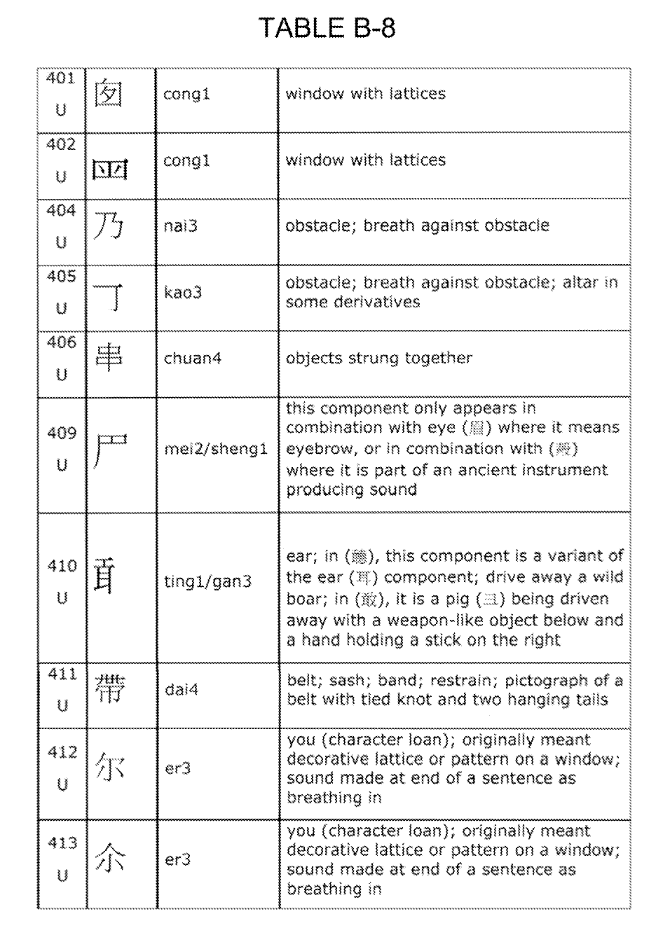

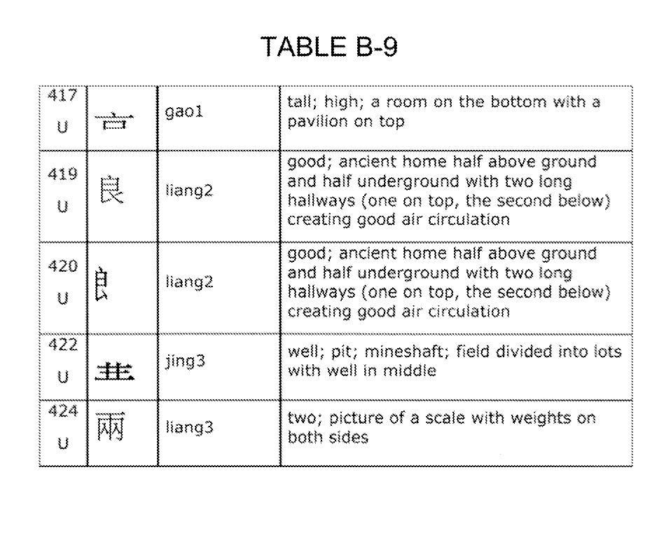

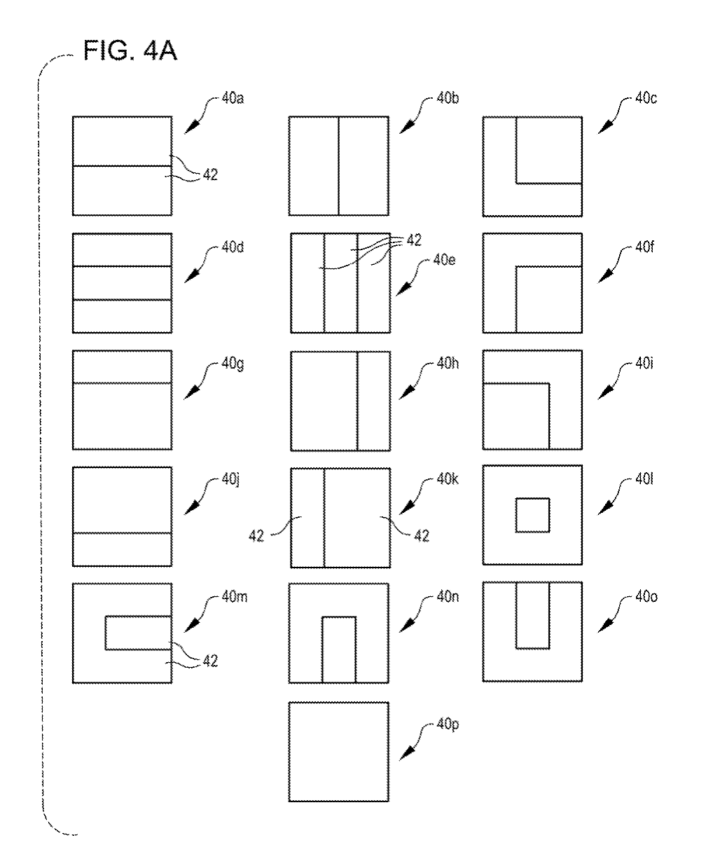

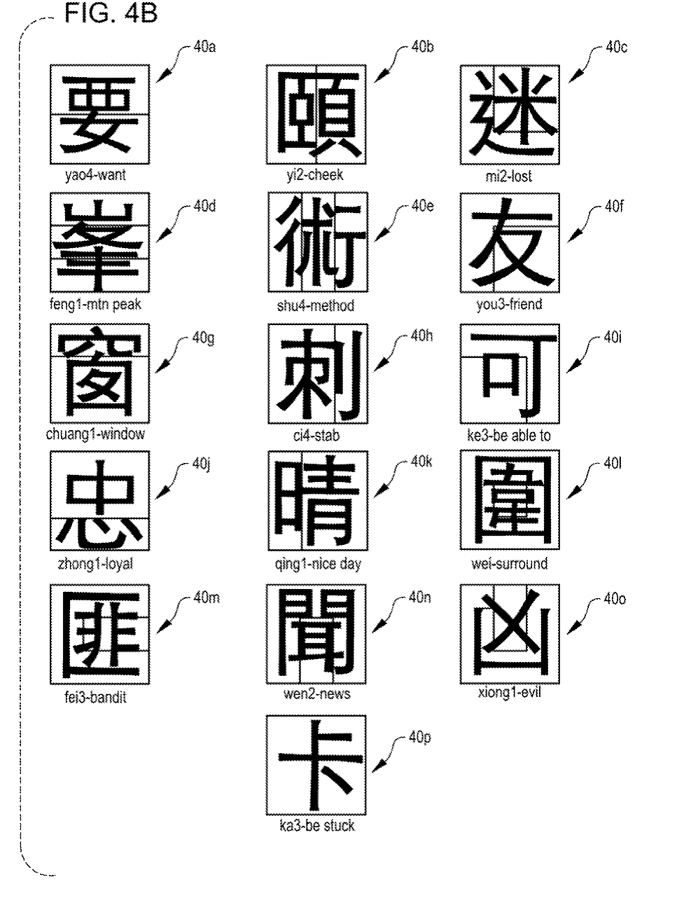

Teaching how to combine one or more components in a group with one or more other components in the group to form a Chinese character includes teaching how to combine visually and semantically two or more of the components (as discussed in greater detail in conjunction with FIGS. 4-10). Thus, teaching how to combine two or more of the components to form a character is different than teaching each component, and includes more than simply showing an example of how a component is visually a portion of a character.

By first teaching each component in the group of components and each component's semantic meaning, a student can become knowledgeable and familiar with each component. The student can then use this depth of understanding to quickly and efficiently recognize and understand Chinese characters—including ones that he may not have previously memorized, or previously memorized and subsequently forgot. Thus, the components in the group of components become similar to the letters in an alphabet of a phonetic language. In addition, by learning each component in the group before learning how to combine them to form characters, one does not have to learn by rote memorization each of the three thousand or more Chinese characters, but rather, the fewer components and then learn how to combine two or more of the components to form a character.

Still referring to FIG. 1, in this and other embodiments of the method, one begins at step 20 by first teaching a component in the group of components. Then, at step 22, one teaches another component in the group of components. Then, at step 23, one determines whether or not all of the components in the group have been taught. If they haven't, then one proceeds back to step 25 and teaches yet another component in the group that has not been previously taught. If, however, all of the components in the group have been taught, then one proceeds to step 24, in which one teaches how to combine two or more components in the group of components to form a Chinese character.

Although methods and systems are discussed in the context of teaching or learning how to read and/or write Chinese, the method can be used to teach or learn how to read and/or write other graphical languages such as Japanese and Korean.

FIG. 2 shows Table A which includes a list of components identified in the group of components mentioned in FIG. 1, according to an embodiment of the invention. Please note that Table A includes four hundred twenty five (425) components with each component's pronunciation and semantic meaning, and thus FIG. 2 spans forty three (43) sheets or pages.

In Table A the components are shown in the column 26 with each component shown in a respective one of four hundred twenty five (425) rows 28 (only five labeled for clarity). Column 30 shows the pronunciation of all the components with each component's pronunciation shown in a respective one of the four hundred twenty five (425) rows 28. Column 32 shows the semantic meaning of all the components with each component's semantic meaning shown in a respective one of the four hundred twenty five (425) rows 28. Column 34 shows the classification of all the components with each component's classification shown in a respective one of the four hundred twenty five (425) rows 28. Each of the components is classified as either a Bùsh\check{o}u used in either or both the Shuowen Jiezi dictionary or the Kangxi Zidian dictionary, or a semantic component that is common to two or more other characters and that is not a Bùsh\check{o}u. An “S” in the column 34 indicates that the component in the same row 28 is also a Bùsh\check{o}u used in the Shuowen Jiezi dictionary. A “K” in the column 34 indicates that the component in the same row 28 is also a Bùsh\check{o}u used in the Kangxi Zidian dictionary. And a “U” in the column 34 indicates that the component in the same row 28 is not a Bùsh\check{o}u.

FIG. 3 shows Table B which includes a subset of components that are each included in Table A shown in FIG. 2, according to an embodiment of the invention. Please note that Table B includes eighty five (85) components that are not Bùsh\check{o}u with each component's pronunciation and semantic meaning, and thus FIG. 3 spans nine (9) sheets or pages. Table B is formatted similar to Table A. Specifically, columns 26, 30, 32 and 34 each respectively show the form, pronunciation, semantic meaning, and classification (all the same in Table B) for each of the respective non-Bùsh\check{o}u components shown in a respective one of the eighty five (85) rows 28 (only five labeled for clarity). The number shown in the column 34 is the same number as that shown in Table A for the same component.

Any desired component may be included in this group of non-Bùsh\check{o}u components provided that the component is also common to two or more characters and has a semantic meaning that contributes to the semantic meaning of the character that includes it. In this and other embodiments, the group of non-Bùsh\check{o}u components includes eighty five (85) components, with some of the components being a compound component.

A compound component is a component that includes two or more other components from the group of non-Bùsh\check{o}u components, the group of Bùsh\check{o}u components (those classified as “S” and/or “K” in Table A), or both groups. Compound components are included in this list because the semantic meaning of the compound component is different than the combination of the semantic meanings of the individual components that make the compound component. Thus, the semantic meaning of a character that includes the compound component is more accurately suggested by the semantic meaning of the compound component, not the semantic meanings of the components that make the compound component. For example, the compound component [symbol] (number 209 in Table A) looks like a combination of [symbol] (number 204 in Table A), which means hand, and [symbol] (number 365 in Table A), which means table, but it is actually a pictograph of a hand holding a club and means weapon or club. As another example, the compound component [symbol] (322 in Tables A and B) looks like a combination [symbol] of (number 342 in Table A), which means small, and [symbol] (number 373 in Table A), which means boundary, and [symbol] (number 111 in Table A), which means opening. But, it's actually a combination of [symbol] (number 310 in Table A), which means divide, and the Chinese character [symbol] , which means direction; and thus [symbol] means dividing in one direction; appreciate, increase. Thus, the semantic meaning of a character that includes the compound component is more accurately suggested by the semantic meaning of the compound component, not the semantic meanings of the components that (appear) make the compound component.

FIGS. 4A and 4B are charts showing possible locations of each component within a Chinese character. FIG. 4A shows the zones in which components can be positioned relative to other components to form a character within a region. FIG. 4B shows examples of components positioned in the zones shown in FIG. 4A to form a character within a region.

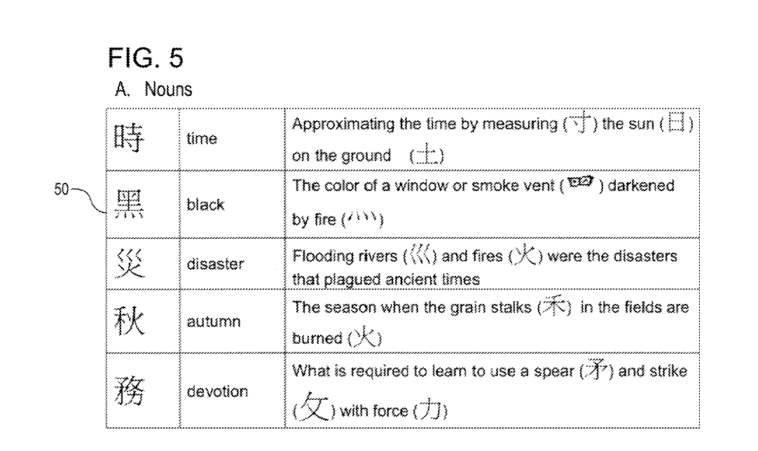

Teaching how to combine two or more components to form a Chinese character includes teaching how to graphically combine the components to form the visual design of the character, and teaching how to use the semantic meanings of the components to determine the semantic meaning of the character, which is discussed in greater detail in conjunction with FIGS. 5-10. Teaching how to graphically combine two or more components to form the character includes following the conventional process for combining components. The conventional process includes placing components adjacent each other, and/or merging a portion of two or more components together, to provide a character that is visually balanced and pleasing to the eye.

More specifically, FIG. 4A shows sixteen (16) regions 40a-40p in each of which a Chinese character may be shown. Each of the regions 40a-40o includes two or more zones 42 (only nine labeled for clarity) in each of which a component may be drawn or shown. As shown in FIG. 4A, the region 40a is subdivided into two, equal-area zones 42, one disposed above the other. The region 40m, however, is subdivided into two, unequal-area zones 42. Examples of characters that are formed by components that are visually shown adjacent other components in the character are found in FIG. 4B. These examples show characters in respective regions 40a-40o composed of components positioned in respective zones 42 of the respective regions 40a-40o. The components in red influence the pronunciation of the character. In region 40p in FIG. 4B, an example of a character that includes two or more components, portions of which are merged with the other, is shown. [symbol] includes the component [symbol] visually combined with the component [symbol] . When [symbol] and [symbol] are combined to form [symbol] , the long horizontal line in each component merges with the other long horizontal line in the other component to form one, long, horizontal line in [symbol] .

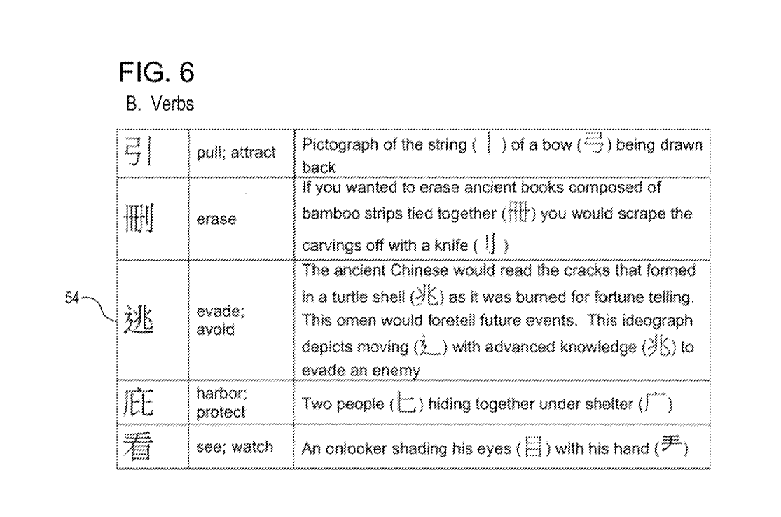

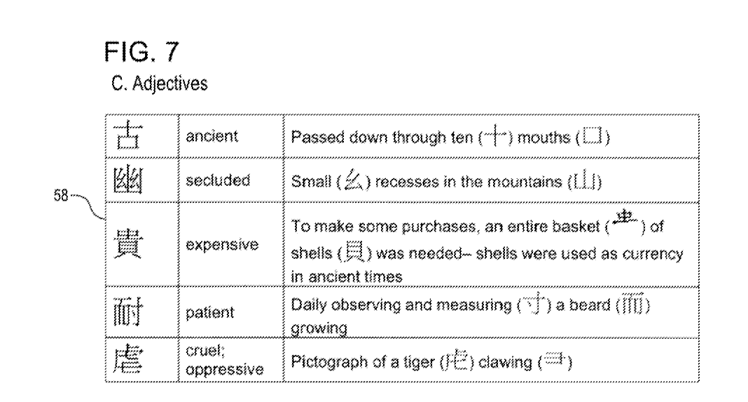

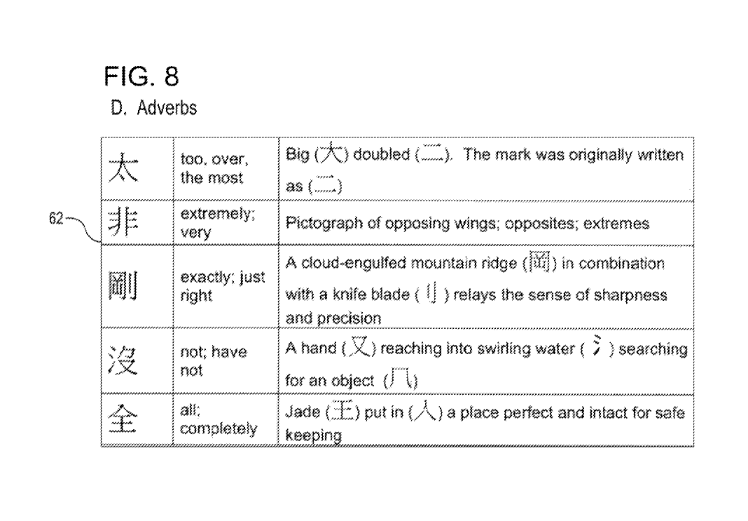

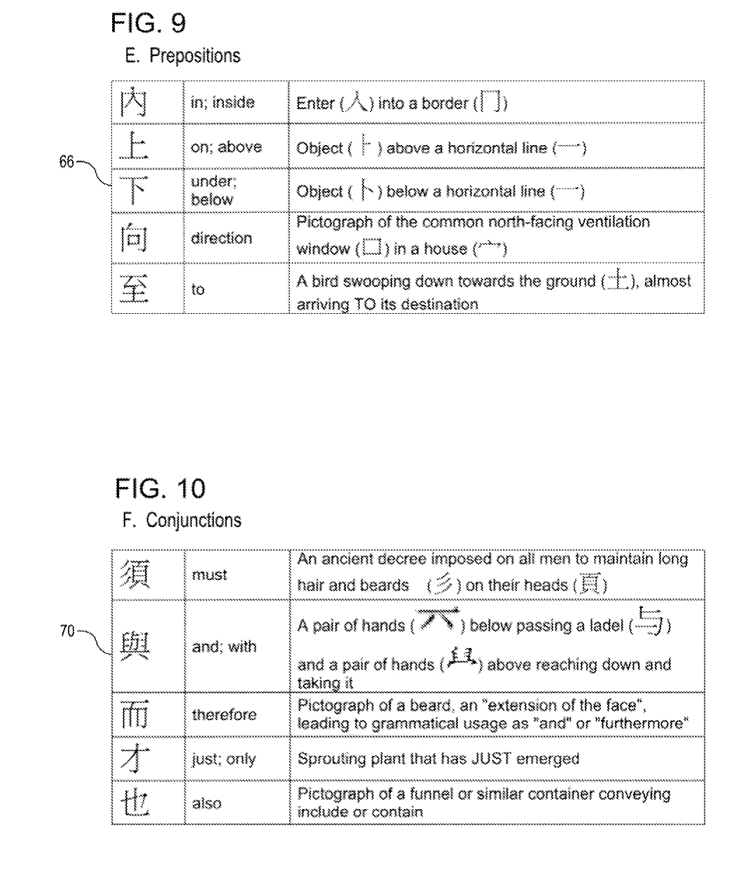

FIGS. 5-10 show examples of Chinese characters that are formed by combining two or more characters from the group of characters identified in Table A of FIG. 2. FIG. 5 shows examples of nouns, and FIG. 6 shows examples of verbs. FIG. 7 shows examples of adjectives, and FIG. 8 shows examples of adverbs. FIG. 9 shows examples of prepositions, and FIG. 10 shows examples of conjunctions. Each of the examples in the figures illustrates how to use the semantic meanings of the components to develop the semantic meaning of the character.

For example, in FIG. 5 [symbol] 50 means black, and includes the component [symbol] (number 402 in Tables A and B), which means window, and the component [symbol] (number 153 in Table A), which means fire. Combining the semantic meanings of these two components suggests a window that is darkened by fire such as a smoke vent, which is often black. Thus, [symbol] 50 means black.

In FIG. 6, [symbol] 54 means evade or avoid, and includes the component [symbol] (number 304 in Tables A and B) and the component [symbol] (number 124 in Table A). [symbol] means omen or foretell, and depicts cracks that formed in a turtle shell as it was burned for fortune telling. [symbol] means movement or process, or stop and go, and depicts a foot halted on a path. Combining the semantic meanings of these two components suggests moving with advanced knowledge to evade. Thus, [symbol] 54 means evade or avoid.

In FIG. 7, [symbol] 58 means ancient, and includes the component [symbol] (number 328 in Table A), which means ten, and the component [symbol] (number 111 in Table A), which means mouth. Combining the semantic meanings of these two components suggests a long time. Thus, [symbol] 58 means ancient.

In FIG. 8, [symbol] 62 means not or have not, and includes the component [symbol] (number 104 in Table A), which means hand, the component [symbol] (number 149 in Table A), which means swirling water, and the component [symbol] (number 95 in Table A), which means short wing. Combining the semantic meanings of these three components suggests a hand reaching into swirling water searching for an object. Thus, [symbol] 62 means not or have not.

In FIG. 9, [symbol] 66 means under or below, and includes the component [symbol] (number 303 in Table A), which means stick or object, and the component—(number 325 in Table A), which means horizontal or horizon. Combining the semantic meanings of these two components suggests an object below a horizontal line. Thus, [symbol] 66 means under or below. In this and other embodiments of the method for teaching, [symbol] is also itself a component included in the group of components shown in Table A and the subset of these components shown in Table B.

In FIG. 10, [symbol] 70 means and or with, and includes the component [symbol] (number 214 in Tables A and B), which means a pair of hands, the component [symbol] (number 230 in Tables A and B), which means ladle, and the component [symbol] (number 218 in Tables A and B), which means hands reaching down. Combining the semantic meanings of these three components suggests a pair of hands passing a ladle to another pair of hands. Thus, [symbol] 70 means and or with.

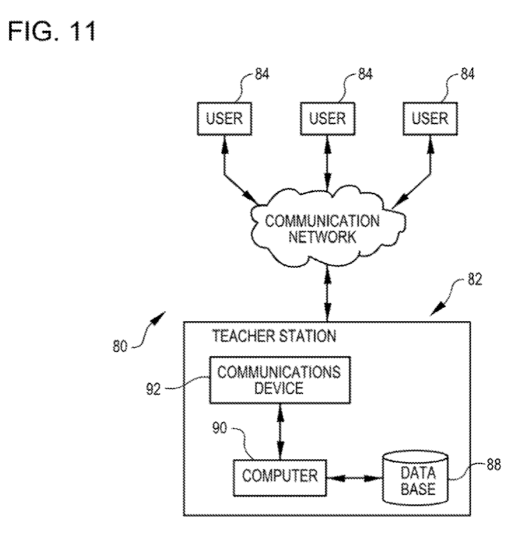

FIG. 11 is a schematic block diagram of a system 80 for teaching how to read and/or write Chinese, according to an embodiment of the invention. The system 80 includes a teacher station 82 and a user station 84 that communicate with each other via a communication network 86. In other embodiments of the system, the teacher station 82 may communicate directly with the user station 84. For example, the user station 84 may connect directly to the teacher station 82 similar to a dummy terminal extending one's access to a mainframe computer. In yet other embodiments of the system, the user station 84 may not communicate with the station 84. For example, a user may engage the teacher station 82 directly, that is, without using a user station 84. This can occur if a user purchases the data files and application program disposed on storage media such as a floppy disc, compact disc, magnetic tape, or removable hard drive, that allow the user's personal computer to teach offline how to read and write Chinese.

The teacher station 82 includes a database 88 of information pertaining to Chinese characters and a group of components each of which is combinable with another component in the group to form a Chinese character. The information in the database 88 includes information about how to draw or visually form each component and many characters, as well as the semantic meaning of each component and many characters. The teacher station 82 also includes electronic circuitry (not shown) having a processor (also not shown) that can execute instructions included in a software program, and a teaching program (also not shown) that when executed by the processor causes the teacher station 82 to teach a user of the station 84 each component in the group of components before teaching how to combine one or more of the components in the group with one or more of the other components in the group to form a Chinese character.

The group of components may include any desired components as previously discussed in conjunction with FIGS. 1-3. In this and other embodiments of the system, the group of components includes the group shown in Table A of FIG. 3, which includes components that are not Bùsh\check{o}u, that are common to two or more characters, and that have a semantic meaning that contributes to the semantic meaning of the character that includes it.

The electronic circuitry, processor and software program may be any desired circuitry, processor and software program that allows the teacher station 84 to teach a user how to read and/or write Chinese by executing the teaching program. For example, in this and other embodiments, the teacher station 82 includes a conventional personal computer 90 whose operating system software can be any desired system software such as Windows XP, Windows 7, OS X (Mac), or Linux, that can support the hardware and software used by the teacher program to teach how to read and/or write Chinese. In other embodiments, the teacher station 82 may include a mobile device such as an iPhone, iPad, or Android. The electronic circuitry includes conventional circuitry and related hardware for receiving input from a user, executing instructions of the teaching program, and conveying output to a user. The teacher station 82 also includes a communications device 92 that can be any desired modem that can support any desired networking protocol. For example, the modem and corresponding software can support TCP/IP networking protocol used to communicate via the Internet or the modem and corresponding software can support other networking protocols such as Ethernet local area network protocol or conventional wireless network protocols.

In other embodiments of the teacher station 82, the station 82 includes a web server (not shown) to facilitate the transfer of information between the teacher station 82 and the user station 84. For example, the web server can include Windows NT as operating system software and an active server pages module (ASP.NET).

What is claimed is:

1. A method for teaching how to read and/or write Chinese, the method comprising:
teaching each component in a group of components wherein:
the group of components includes a component that is not identified as a Bùsh\check{o}u, and
each component in the group is combinable with one or more other components in the group to form a Chinese character,
before teaching how to combine one or more of the components in the group with one or more of the other components in the group to form a Chinese character.

2. The method of claim 1 further comprising teaching how to combine one or more of the components in the group with one or more of the other components in the group to form a Chinese character, after teaching each component in the group of components.

3. The method of claim 1 wherein each component has a semantic meaning.

4. The method of claim 1 wherein a single component may form a Chinese character.

5. The method of claim 1 wherein the group of components includes the components identified in Table B (FIG. 3).

6. The method of claim 1 wherein the group of components includes the four hundred twenty five (425) components identified in Table A (FIG. 2).

7. The method of claim 1 wherein teaching each component includes teaching a semantic meaning of each component.

8. The method of claim 1 wherein teaching each component includes showing an example of how two or more components are combined to form a Chinese character.

9. The method of claim 2 wherein teaching how to combine two or more of the components in the group of components to form a Chinese character includes teaching how to combine the semantic meanings of the two or more components to understand the semantic meaning of the Chinese character.

10. A system for teaching how to read and/or write Chinese, the system comprising:
a teacher station that includes:
electronic circuitry having a processor and operable to execute instructions included in a software program;
a database having a group of components wherein:
the group of components includes a component that is not identified as a Bùsh\check{o}u, and
each component in the group is combinable with one or more other components in the group to form a Chinese character,
a teaching program that when executed by the processor of the electronic circuitry causes the teacher station to teach a user of the station each component in the group of components, before a user is taught how to combine one or more of the components in the group with one or more of the other components in the group to form a Chinese character.

11. The system of claim 10 wherein the teaching program also teaches how to combine one or more of the components in the group with one or more of the other components in the group to form a Chinese character, when the teaching program is executed by the processor.

12. The system of claim 10 wherein each component in the group of components has a semantic meaning.

13. The system of claim 10 wherein a single component may form a Chinese character.

14. The system of claim 10 wherein the group of components includes the components identified in Table B (FIG. 3).

15. The system of claim 10 wherein the group of components includes the four hundred twenty five (425) components identified in Table A (FIG. 2).

16. The system of claim 10 wherein teaching each component includes teaching a semantic meaning of each component.

17. The system of claim 10 wherein teaching each component includes showing an example of how two or more components are combined to form a Chinese character.

18. The system of claim 11 wherein teaching how to combine two or more of the components in the group of components to form a Chinese character includes teaching how to combine the semantic meanings of the two or more components to understand the semantic meaning of the Chinese character.

19. The system of claim 10 wherein the teacher station includes a computer that contains each of the following: the electronic circuitry, the database, and the teacher program to be executed by the electronic circuitry.

20. The system of claim 10 further comprising a communication network that allows the teacher station to teach a person at a location different than the location of the teacher station, each component in the group of components before teaching how to combine one or more of the components in the group with one or more of the other components in the group to form a Chinese character.

21. A method for teaching how to read and/or write Chinese, the method comprising:
teaching each component in a group of components that consists of the components identified in Table A (FIG. 2), wherein each component in the group is combinable with one or more other components in the group to form a Chinese character, before teaching how to combine one or more of the components in the group with one or more other components to form a Chinese character.

22. The method of claim 21 further comprising teaching how to combine one or more of the components in the group with one or more other components to form a Chinese character.

23. The method of claim 21 wherein each component has a semantic meaning.

24. The method of claim 21 wherein a single component may form a Chinese character.

25. The method of claim 21 wherein teaching each component includes learning a semantic meaning of each component.

26. The method of claim 21 wherein teaching each component includes showing an example of how two or more components are combined to form a Chinese character.

27. The method of claim 22 wherein teaching how to combine two or more of the components in the group of components to form a Chinese character includes teaching how to combine the semantic meanings of the two or more components to understand the semantic meaning of the Chinese character.

28. A method for learning how to read and/or write Chinese, the method comprising:
learning each component in a group of components wherein:
the group of components includes a component that is not identified as a Bùsh\check{o}u, and
each component in the group is combinable with one or more other components in the group to form a Chinese character,
before studying how to combine one or more of the components in the group with one or more of the other components in the group to form a Chinese character.

29. The method of claim 28 further comprising studying how to combine one or more of the components in the group with one or more of the other components in the group to form a Chinese character.

30. The method of claim 28 wherein each component has a semantic meaning when the component is used alone as a Chinese character.

31. The method of claim 28 wherein the group of components includes the components identified in Table B (FIG. 3).

32. The method of claim 28 wherein the group of components includes the four hundred twenty five (425) components identified in Table A (FIG. 2).

33. The method of claim 28 wherein learning each component includes learning a semantic meaning of each component.

34. The method of claim 28 wherein learning each component includes showing an example of how two or more components are combined to form a Chinese character.

35. The method of claim 29 wherein learning how to combine two or more of the components in the group of components to form a Chinese character includes studying how to combine the semantic meanings of the two or more components to understand the semantic meaning of the Chinese character.

36. A method for learning to read and/or write Chinese, the method comprising:
learning each component in a group of components that consists of the components identified in Table A (FIG. 2), wherein each component in the group is combinable with one or more other components in the group to form a Chinese character, before studying how to combine one or more of the components in the group with one or more other components to form a Chinese character.

37. The method of claim 36 further comprising studying how to combine one or more of the components in the group with one or more other components to form a Chinese character.

38. The method of claim 36 wherein each component has a semantic meaning when the component is used alone as a Chinese character.

39. The method of claim 36 wherein learning each component includes learning a semantic meaning of each component.

40. The method of claim 36 wherein learning each component includes seeing an example of how two or more components are combined to form a Chinese character.

41. The method of claim 37 wherein studying how to combine two or more of the components in the group of components to form a Chinese character includes studying how to combine the semantic meanings of the two or more components to understand the semantic meaning of the Chinese character.

42. A method for teaching how to read and/or write Chinese, the method comprising:
teaching each component in a group of components wherein:
the group of components includes a component that is identified as a Bùsh\check{o}u, and
each component in the group is combinable with one or more other components in the group to form a Chinese character,
before teaching how to combine one or more of the components in the group with one or more of the other components in the group to form a Chinese character.

43. The method of claim 42 further comprising teaching how to combine one or more of the components in the group with one or more of the other components in the group to form a Chinese character.

44. The method of claim 42 wherein the group of components includes a component that is not identified as a Bùsh\check{o}u.
